(19) United States
(12) Patent Application Publication
(10) Pub. No.: US 2012/0218752 A1
(43) Pub. Date: Aug. 30, 2012

(54) LIGHT SOURCE MODULE AND OPTICAL MEMBER

(76) Inventor: Ken SUMITANI, Osaka (JP)

(21) Appl. No.: 13/325,798

(22) Filed: Dec. 14, 2011

(30) Foreign Application Priority Data
Feb. 24, 2011 (JP) 2011-038050

(51) Int. Cl. F21V 11/00

(52) U.S. Cl. 362/235; 362/296.01; 362/307

(57) ABSTRACT

A light source module includes: a light source; a lighting curtain that partially blocks light from the light source; and a reflective layer that is provided on the lighting curtain and that has a planar shape smaller than the lighting curtain.

This application is based on Japanese Patent Application No. 2011-038050 filed on Feb. 24, 2011, the contents of which are hereby incorporated by reference.

### BACKGROUND OF THE INVENTION

1. Field of the Invention

The present invention relates to a light source module and an optical member that is used in the light source module.

2. Description of the Related Art

Conventionally, there is known a light source module that generates planar illumination light and that illuminates a member to be illuminated; the light source module is used as a backlight unit arranged in a liquid crystal display device or the like (for example, see patent document 1).

Conventionally, as a light source of the light source module, a CCFL (cold cathode fluorescent lamp) that seals mercury or xenon in a fluorescent lamp or the like is mainly used. However, when the CCFL is used as the light source of the light source module, the brightness of light emitted and the life are unsatisfactory. Furthermore, disadvantageously, the brightness on a low voltage side is decreased, and thus it is difficult to achieve uniform light emission. Hence, in order to eliminate such a disadvantage, instead of the CCFL, a light source module that uses an LED (light-emitting diode) package as a light source is proposed.

An example of the configuration of the conventionally proposed light source module will be described briefly below with reference to FIG. 43.

In the conventionally proposed light source module, as shown in FIG. 43, a plurality of LED packages 720 that are a light source are held within an enclosure 710 having an opening for light emission. Within the enclosure 710, a reflective sheet 730 that reflects light is also held. In the reflective sheet 730, exposure holes are formed, and the LED packages 720 are exposed (protrude) through the exposure holes.

A lighting curtain 740 is attached to the opening of the enclosure 710; the lighting curtain 740 blocks the opening of the enclosure 710. On the predetermined surface (the surface opposite the surface facing the LED packages 720) of the lighting curtain 740, a diffusion plate 750 that diffuses light is arranged.

The intensity of light that is emitted from the LED packages 720 and that is incident on the lighting curtain 740 depends on portions of the lighting curtain 740. Hence, processing for reducing the amount of light transmitted is performed on the portions of the lighting curtain 740 on which a large amount of light is incident. On the other hand, processing for increasing the amount of light transmitted is performed on the portions of the lighting curtain 740 on which a small amount of light is incident. Thus, variations in brightness are unlikely to be produced in planar light emitted from the lighting curtain 740. The light emitted from the predetermined surface of the lighting curtain 740 is diffused by the diffusion plate 750, and thereafter illuminates, as illumination light, a member to be illuminated.

As a method of configuring a lighting curtain such that the amount of light transmitted depends on its portions, various methods are known. For example, in patent document 2, a lighting curtain is formed with a transparent plate to which a reflective material is applied, and the transmittance is adjusted by the pattern of the application of the reflective member. Moreover, in patent document 3, a lighting curtain is formed with a reflective plate having an opening, and the transmittance is adjusted by the opening. Furthermore, as a method similar to that of patent document 2, patent document 4 discloses a configuration in which, instead of the transparent plate of patent document 2, a diffusion plate is used. In patent document 4, a plurality of lighting curtains are used such that they are stacked.

Patent document 1: JP-A-64-72193

Patent document 2: JP-A-2010-192301

Patent document 3: JP-A-2009-110696

Patent document 4: JP-A-2002-313103

When LED packages are used as the light source of a light source module, since the LED packages serving as the light source have high directivity as compared with a CCFL, a larger amount of light is concentrated in an area substantially directly above the light source. This tendency becomes greater as the thickness of the light module is reduced. In other words, the thickness of the light source module is reduced, and thus the light having a higher intensity is applied to the area substantially directly above the light source. When, as described above, a significantly large amount of light is applied to a specific portion of the lighting curtain, the lighting curtain is required to have the ability to sufficiently block the light.

However, the lighting curtains disclosed in patent documents 1 to 3 do not always have their sufficient blocking ability. Hence, when the lighting curtains disclosed in patent documents 1 to 3 are used in the conventional light source modules, the blocking ability is not sufficient, and thus an excessive amount of light passes through portions that need to block the light. Therefore, since the excessive amount of light passes through the portions and thus the portions become bright, variations in brightness are produced in the planar illumination light.

In the lighting curtain disclosed in patent document 3, if the thickness of the reflective plate of the lighting curtain is increased, it is possible to acquire a high blocking ability. However, in this case, the increased thickness of the lighting curtain disadvantageously causes the thickness of the light source module to be increased. Since the increased thickness of the reflective plate (the lighting curtain) makes it difficult to process the opening, it is disadvantageously difficult to obtain the lighting curtain (light source module) that can effectively reduce variations in brightness.

As disclosed in patent document 4, when a plurality of lighting curtains are stacked, it is possible to acquire a high blocking ability; however, even in this case, since the thickness of the lighting curtain is increased, the thickness of the light source module is disadvantageously increased. Moreover, in this case, problems such as the displacement of positions between the lighting curtains and the increased number of assembly steps are newly produced. Hence, the lighting curtains disclosed in patent documents 3 and 4 do not sufficiently function as solutions.

As described above, in the conventional light source module, when a light source having a high directivity is used or when the thickness of the module is reduced, it is disadvantageously difficult to obtain uniform illumination light. In the conventional light source module, when a light source having a high directivity is used in order to obtain uniform illumination light, it is also disadvantageously difficult to reduce the thickness of the module.

Since, in particular, a liquid crystal television having a small thickness is desired, it is desirable to reduce the thickness of a light source module that is used as a backlight unit. However, the reduced thickness of the light source module causes variations in brightness to be more disadvantageously produced.

### SUMMARY OF THE INVENTION

The present invention is made to overcome the above problems; an object of the present invention is to provide a light source module that can illuminate a member to be illuminated without variations in brightness even when a light source having a high directivity is used or even when the thickness of the module is reduced.

Another object of the present invention is to provide a light source module that can emit, even when a light source having a high directivity is used, uniform illumination light having variations in brightness reduced while reducing the thickness of the module.

Yet another object of the present invention is to provide an optical member that has a sufficient blocking ability and that can improve the uniformity of light.

To achieve the above objects, according to a first aspect of the present invention, there is provided a light source module including: a light source; a lighting curtain that partially blocks light from the light source; and a reflective layer that is provided on the lighting curtain and that has a planar shape smaller than the lighting curtain.

In the light source module of the first aspect, as described above, the reflective layer is provided on the lighting curtain such that, when a large amount of light is applied from the light source to an area of the lighting curtain, the light can be blocked by both the reflective layer and the lighting curtain. Hence, since a sufficient light blocking ability can be acquired, even when a large amount of light is applied remarkably to a specific portion of the lighting curtain, the light can be satisfactorily blocked. Thus, it is possible to make it unlikely that, even when a light source having a high directivity is used or even when the thickness of the module is reduced, variations in the brightness of the light (illumination light) that is emitted through the lighting curtain are produced.

In the first aspect, the reflective layer has a planar shape smaller than the lighting curtain, and thus it is possible to provide the reflective layer in only the area to which a large amount of light is applied from the light source. Thus, it is possible to reduce the increases in the material cost, the weight and the like as compared with the case where, in order for the light blocking ability of the lighting curtain to be enhanced, the thickness of the lighting curtain is increased or a plurality of lighting curtains are stacked. When the reflective sheet segments are provided in the lighting curtain, the thickness of the lighting curtain itself is not increased. Hence, it is also possible to prevent the thickness of the light source module from being increased due to the increase in the thickness of the lighting curtain.

As described above, in the light source module of the first aspect, even when a light source having a high directivity is used, it is possible to reduce the thickness of the module. Even in the configuration described above, it is possible to emit uniform illumination light having variations in brightness reduced.

Furthermore, in the first aspect, in the configuration described above, it is possible to enhance the light blocking ability without the use of a plurality of lighting curtains. Thus, it is possible to prevent disadvantages produced when a plurality of lighting curtains are used. For example, it is possible to eliminate the need to give consideration to the attachment of a plurality of lighting curtains and the positioning of the lighting curtains when the light source module is assembled. Consequently, it is possible to, for example, enhance the accuracy of attachment of the lighting curtain, reduce the cost in the attachment step and enhance the throughput in the attachment step.

In the light source module of the first aspect, as the lighting curtain, the lighting curtain formed with the reflective plate including the transmission portions formed by the openings can be used. The reflective layers are provided in the lighting curtain described above, and thus it is possible to acquire the light source module that can easily and uniformly illuminate a member to be illuminated.

Even in this case, an opening hole can be provided in the reflective layer so as to cover the opening of the lighting curtain. In the configuration described above, since a portion having a high light blocking ability can be arranged adjacently to the opening, it is possible to enhance the light blocking ability over the vicinity of the opening.

The reflective layer can be fixed to the lighting curtain through an adhesion layer. When the opening hole is provided in the reflective layer, the adhesion layer is preferably provided in an area in which the adhesion layer is prevented from covering the opening hole of the reflective layer.

When, as the lighting curtain, a lighting curtain formed with the reflective plate in which the transmission portion is formed by the opening is used, at least part of the opening of the lighting curtain may be covered by the reflective layer. In the configuration described above, it is possible to form, for example, an area which has an intermediate light blocking ability, that is, in which the light is transmitted through the lighting curtain but is reflected off the reflective layer. Thus, the flexibility of the design of the light source module can be enhanced.

In the light source module of the first aspect, the lighting curtain can also be formed with a plate-shaped member in which a transmission portion and a light blocking portion are provided by printing a reflective material. The reflective layers are provided in the lighting curtain described above, and thus it is possible to acquire the light source module that can easily and uniformly illuminate the member to be illuminated without unevenness.

In this case, the lighting curtain preferably includes: a transparent plate; and a print layer that is formed by printing the reflective material on both surfaces of the transparent plate. In the configuration described above, since the print layer is formed on both surfaces of the transparent plate, it is possible to enhance the light blocking ability of the lighting curtain. In this case, the printing pattern of the reflective material on each surface and the position and the shape of the reflective layer are more preferably set such that, among the light emitted from the light source, light that is emitted at such an angle that a predetermined amount or more of strength is acquired is applied either to the reflective material (the print layer) printed on any one of the surfaces of the transparent plate or to the reflective layer.

Preferably, in the light source module of the first aspect, the reflective layer is formed into a separate sheet shape, and the sheet-shaped reflective layer is fixed to the lighting curtain through an adhesion layer.

In this case, the adhesion layer may be formed by printing an adhesion material on the sheet-shaped reflective layer, and the adhesion layer may be formed by printing an adhesion material on the lighting curtain. The adhesion layer (the adhesion material) preferably has ultraviolet radiation resistance. Furthermore, the adhesion layer (the adhesion material) is preferably transparent or white.

The sheet-shaped reflective layer can be fixed to the lighting curtain with a double-faced tape having the adhesion layer. The double-faced tape may include a base material; the double-faced tape more preferably includes no base material. When the double-faced tape includes a base material, the base material is preferably transparent or white.

In the light source module of the first aspect, the reflective layer is preferably formed with a first reflective member in which a reflective material is printed on a base material. With this configuration, it is possible to form the light reflecting area (a reflective area on which the reflective material is printed) into a complicated pattern or a fine pattern. Hence, since the reflective material can be accurately applied to the area in which the light blocking characteristic needs to be enhanced, it is possible to easily enhance the light blocking characteristic of the area.

In the light source module of the first aspect, the reflective layer may be formed with a second reflective member in which a reflective material is printed on a formed reflective sheet. In this configuration, since the reflective layer is formed with the reflective sheet and the reflective material printed thereon, the reflective layer is formed of a plurality of layers. Hence, since it is possible to easily enhance the reflection ability of the reflective layer, it is possible to easily enhance the light blocking ability of the lighting curtain on which the reflective is provided.

In the light source module of the first aspect, the light source can be arranged on the side of one surface of the lighting curtain. In this case, the reflective layer may be provided on the surface of the lighting curtain on the side of the light source or on a surface of the lighting curtain opposite the surface on the side of the light source. The reflective layer may also be provided on both the surface of the lighting curtain on the side of the light source and the surface opposite the surface on the side of the light source.

In the light source module of the first aspect, the reflective layer preferably includes: a first reflective layer that is fixed to the lighting curtain; and a second reflective layer that has a planar shape smaller than the first reflective layer and that is fixed to the first reflective layer. With this configuration, it is possible to further enhance the light blocking ability.

Preferably, in the light source module of the first aspect, the reflective layer is substantially circular or substantially quadrangular when seen in plan view. Since, in this configuration, in the design of the shape of the reflective layer, a calculation for determination of the application to the reflective layer can be performed rapidly, the enhancement of efficiency of the design can be expected. When the thickness of the reflective layer is small, the thickness of the reflective layer is set at 0 (zero), and it is possible to perform the calculation effectively. Hence, the thickness of the reflective layer is preferably smaller than that of the lighting curtain.

When the lighting curtain is formed with the reflective plate in which the transmission portion is formed by the opening, the reflective layer is preferably formed and fixed onto the lighting curtain by printing. In this configuration, with simple means, it is possible to locally enhance the light blocking ability of the lighting curtain.

In this case, the reflective layer is preferably formed and fixed onto the lighting curtain by printing a white ink. As described above, the white ink is used for the printing, and thus variations in the color of the light that are thereafter produced can be reduced, with the result that the light blocking ability can be enhanced. The reflective layer may be formed and fixed by printing, for example, a metallic ink other than the white ink on the lighting curtain. When the metallic ink is used for the printing, even if the printing is performed such that its thickness is small (even if the thickness of the print layer is small), it is possible to acquire a high light blocking ability.

In the light source module of the first aspect, at least part of the reflective layer is preferably sealed with a sealant. With this configuration, it is possible to easily prevent the reflective layer from falling off.

In the light source module of the first aspect, the light source is preferably formed with a light-emitting diode.

The light source module of the first aspect preferably includes a plurality of the light sources.

An optical member of a second aspect of the present invention includes: a lighting curtain that partially blocks light; and a reflective layer that is provided on the lighting curtain and that has a planar shape smaller than the lighting curtain. In this configuration, since it is possible to enhance the light blocking ability in an area of the optical member, even if a large amount of light is applied to the area, it is possible to sufficiently block the light. Hence, when the optical member described above is used as the light source module, it is possible to enhance the uniformity of the light emitted from the light source module.

As described above, according to the present invention, it is possible to easily acquire a light source module that can illuminate a member to be illuminated without variations in brightness even when a light source having a high directivity is used or even when the thickness of the module is reduced.

According to the present invention, it is possible to easily acquire a light source module that can emit, even when a light source having a high directivity is used, uniform illumination light having variations in brightness reduced while reducing the thickness of the module.

According to the present invention, it is possible to easily acquire an optical member that has a sufficient blocking ability and that can improve the uniformity of light.

### BRIEF DESCRIPTION OF THE DRAWINGS

FIG. 1 is a cross-sectional view of a light source module according to a first embodiment of the present invention;

FIG. 2 is a cross-sectional view showing an enlarged portion of FIG. 1;

FIG. 3 is a perspective view schematically showing the light source module according to the first embodiment of the present invention (a perspective view of a liquid crystal display device using the light source module as a backlight unit);

FIG. 4 is a partial cutaway plan view of the light source module according to the first embodiment of the present invention;

FIG. 5 is a perspective view of a reflective sheet segment of the light source module according to the first embodiment of the present invention;

FIG. 6 is a plan view showing a portion of an optical member of the light source module according to the first embodiment of the present invention;

FIG. 7 is a perspective view showing a portion of the optical member of the light source module according to the first embodiment of the present invention;

FIG. 8 is a cross-sectional view illustrating a light distribution characteristic when a CCFL is used as a light source;

FIG. 9 is a characteristic diagram illustrating the light distribution characteristic when the CCFL is used as the light source;

FIG. 10 is a cross-sectional view illustrating a light distribution characteristic when the LED package is used as the light source;

FIG. 11 is a characteristic diagram illustrating the light distribution characteristic when the LED package is used as the light source;

FIG. 12 is a cross-sectional view of a light source module according to a second embodiment of the present invention;

FIG. 13 is a cross-sectional view showing an enlarged portion of FIG. 12;

FIG. 14 is a perspective view of a reflective sheet segment of the light source module according to the second embodiment of the present invention;

FIG. 15 is a plan view showing a portion of a lighting curtain of the light source module according to the second embodiment of the present invention;

FIG. 16 is a cross-sectional view of a light source module according to a third embodiment of the present invention;

FIG. 17 is a cross-sectional view showing an enlarged portion of FIG. 16;

FIG. 18 is a perspective view of a reflective sheet segment of the light source module according to the third embodiment of the present invention;

FIG. 19 is a plan view showing a portion of a lighting curtain of the light source module according to the third embodiment of the present invention;

FIG. 20 is a cross-sectional view of a light source module according to a fourth embodiment of the present invention;

FIG. 21 is a cross-sectional view showing an enlarged portion of FIG. 20;

FIG. 22 is a plan view showing a portion of a lighting curtain of the light source module according to the fourth embodiment of the present invention;

FIG. 23 is a cross-sectional view of a light source module according to a fifth embodiment of the present invention;

FIG. 24 is a cross-sectional view showing an enlarged portion of FIG. 20;

FIG. 25 is a plan view showing an enlarged portion of a lighting curtain of the light source module according to the fifth embodiment of the present invention;

FIG. 26 is a cross-sectional view of a light source module according to a sixth embodiment of the present invention;

FIG. 27 is a cross-sectional view showing an enlarged portion of FIG. 26;

FIG. 28 is a perspective view of a reflective sheet segment of the light source module according to the sixth embodiment of the present invention;

FIG. 29 is a cross-sectional view showing a state where the reflective sheet segment is attached in the sixth embodiment of the present invention.

FIG. 30 is a cross-sectional view of a light source module according to a seventh embodiment of the present invention;

FIG. 31 is a cross-sectional view showing an enlarged portion of FIG. 30;

FIG. 32 is a cross-sectional view showing a portion of an optical member of a light source module according to an eighth embodiment of the present invention;

FIG. 33 is a cross-sectional view showing a portion (another example) of the optical member of the light source module according to the eighth embodiment of the present invention;

FIG. 34 is a cross-sectional view of a light source module according to a ninth embodiment of the present invention;

FIG. 35 is a cross-sectional view showing an enlarged portion of FIG. 34;

FIG. 36 is a cross-sectional view of a light source module according to a tenth embodiment of the present invention;

FIG. 37 is a cross-sectional view showing an enlarged portion of FIG. 36;

FIG. 38 is a plan view showing a portion of an optical member according to an eleventh embodiment of the present invention;

FIG. 39 is a plan view showing a portion of an optical member according to the eleventh embodiment of the present invention;

FIG. 40 is a plan view showing a portion of an optical member according to the eleventh embodiment of the present invention;

FIG. 41 is a plan view showing a portion of an optical member according to the eleventh embodiment of the present invention;

FIG. 42 is a plan view showing a portion of an optical member according to a twelfth embodiment of the present invention; and

FIG. 43 is a cross-sectional view showing an example of the configuration of a conventionally proposed light source module.

### DETAILED DESCRIPTION OF THE PREFERRED EMBODIMENTS

Embodiments of the present invention will be described in detail below with reference to accompanying drawings.

### First Embodiment

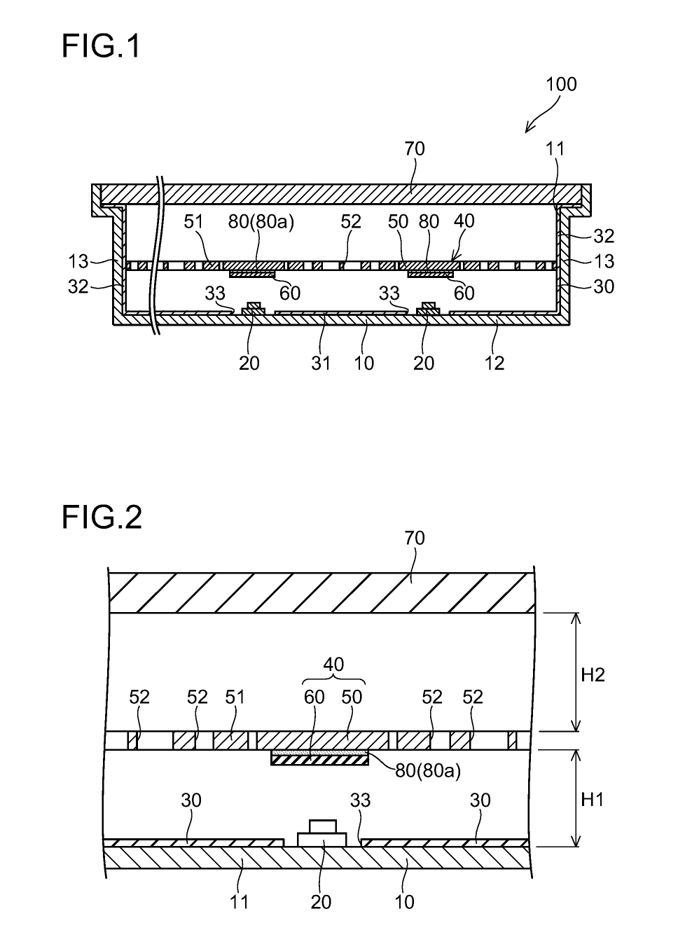

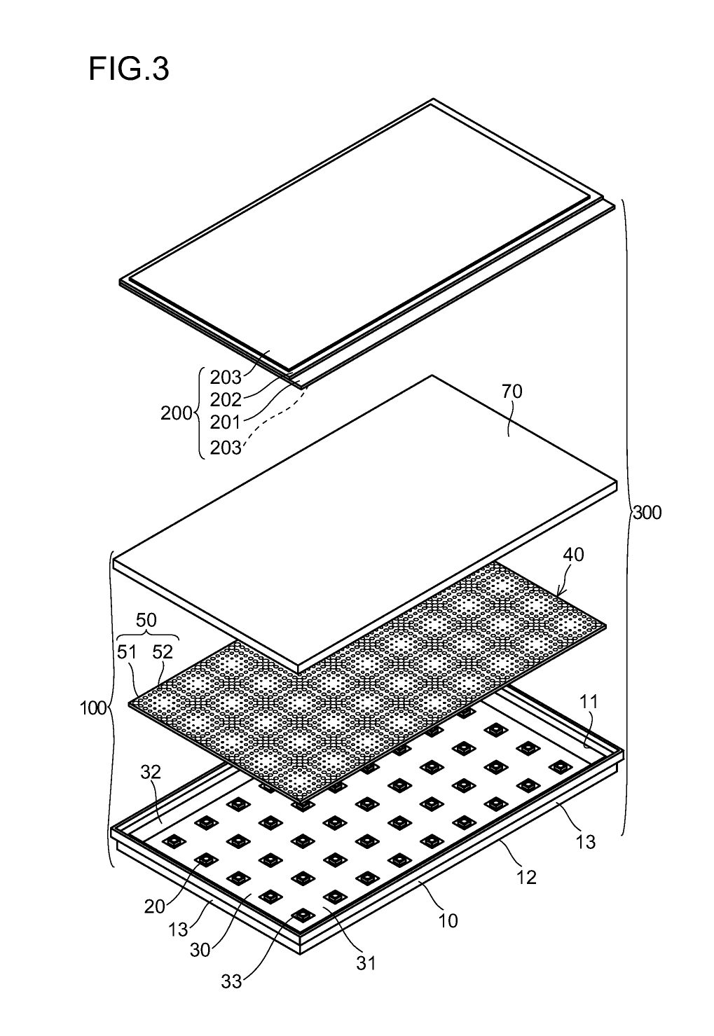

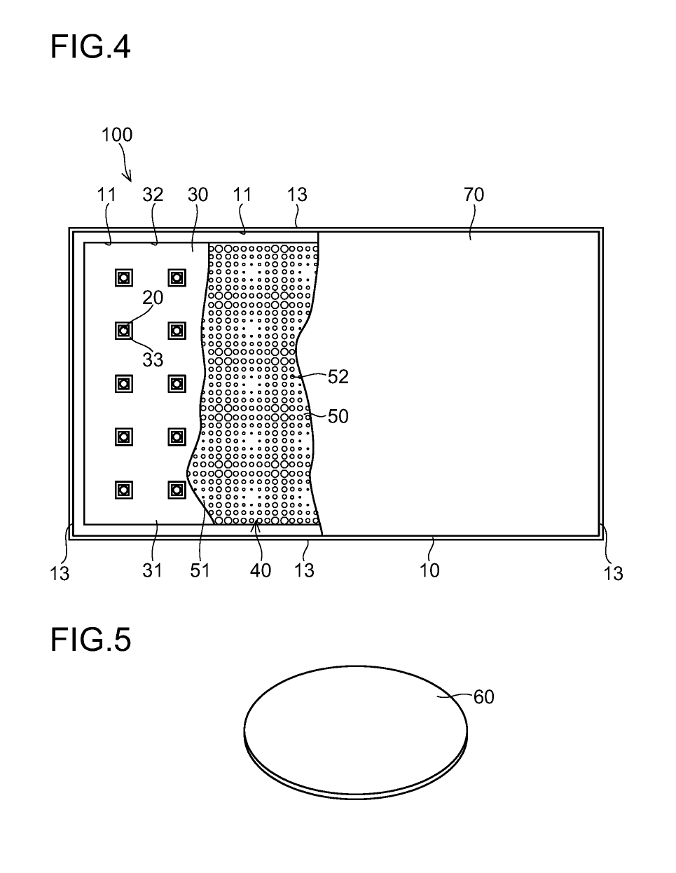

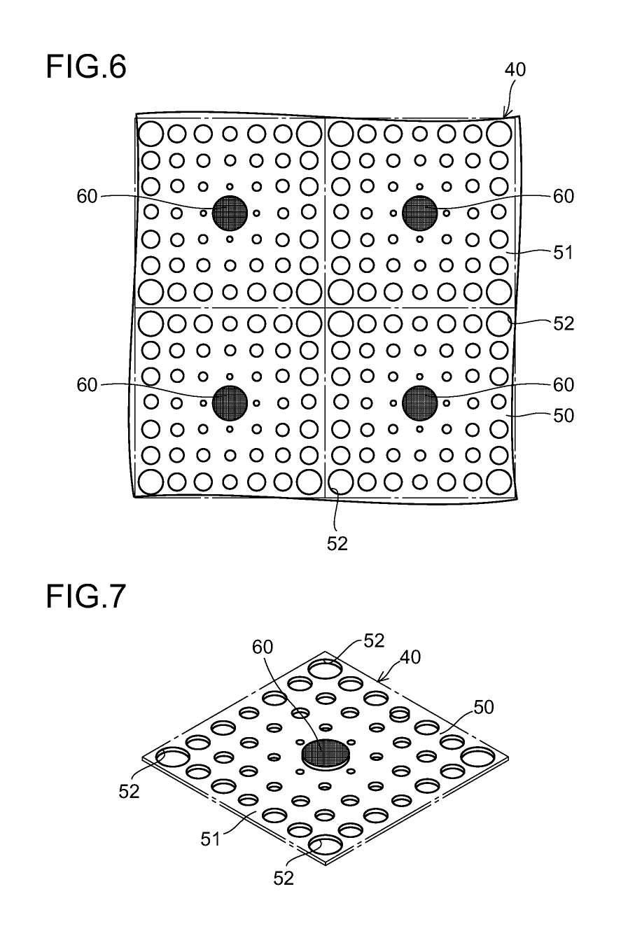

FIG. 1 is a cross-sectional view of a light source module according to a first embodiment of the present invention. FIG. 2 is a cross-sectional view showing an enlarged portion of FIG. 1. FIG. 3 is a perspective view schematically showing the light source module according to the first embodiment of the present invention. FIGS. 4 to 7 are diagrams illustrating the light source module according to the first embodiment of the present invention. The light source module according to the first embodiment of the present embodiment will first be described with reference to FIGS. 1 to 7.

As shown in FIGS. 1 to 3, the light source module 100 of the first embodiment is configured to include an enclosure 10, LED packages 20, a reflective sheet 30 and an optical member 40. The optical member 40 has a lighting curtain 50 and a plurality of reflective sheet segments 60 that are fixed to the lighting curtain 50. Above the lighting curtain 50, a diffusion plate 70 that diffuses light is arranged. The LED packages 20 are an example of a “light source” of the present invention; the reflective sheet segments 60 are an example of a “reflective layer.”

The enclosure 10 is a substantially box-shaped member having an opening 11 for light emission, and includes a bottom portion 12 and a side portion 13 that is provided around the perimeter of the bottom portion 12. This enclosure 10 is formed by processing, for example, a metallic plate-shaped member. The enclosure 10 holds the LED packages 20 and the reflective sheet 30 by placing them over its bottom surface. A region enclosed by the side portion 13 of the enclosure 10 is substantially rectangular; the substantially rectangular region is a holding region that holds the LED packages 20 and the reflective sheet 30.

The LED packages 20 serving as the light source are held within the enclosure 10 while being mounted on a mounting board (unillustrated). The mounting board is a plate-shaped and rectangular board; a plurality of electrodes are arranged on its mounting surface. Onto these electrodes, the LED packages 20 are attached. A plurality of LED packages 20 are mounted on the same mounting board and thus they are combined into modules.

The LED packages 20 are mounted on the electrodes formed on the mounting surface of the mounting board, and thereby receive electric current and emit light. As shown in FIG. 3, a plurality of LED packages serving as the light source are mounted in the holding region of the enclosure 10. These LED packages 20 are structured such that white light is emitted from the light emission surface of each of the LED packages 20. The LED packages 20 are arranged in the holding region of the enclosure 10 (on the bottom surface 12 of the enclosure 10) two-dimensionally (for example, in a lattice).

The LED packages 20 are a top view type. The LED packages of this type often have a high directivity toward an area directly above the LED packages 20. Hence, the light distribution characteristic of the LED packages 20 is assumed to be the same as that described above.

The structure of the LED package 20 is not particularly limited; for example, it is a combination of a fluorescent material that converts blue light into yellow light and a blue LED element. The LED package 20 may also be a combination of a fluorescent material that converts blue light into green light and red light and a blue LED element; the LED package 20 may also be a combination of three types of LED elements that are a red LED element, a green LED element and a blue LED element.

The reflective sheet 30 has the function of reflecting light; for example, it is formed by processing a sheet member formed of resin. The reflective sheet 30 includes a bottom portion 31 and a side portion 32 that is provided around the perimeter of the bottom portion 31. In the bottom portion 31 of the reflective sheet 30, a plurality of exposure holes 33 are provided. These exposure holes 33 are formed to correspond to the LED packages 20 that are arranged two-dimensionally.

As shown in FIGS. 2 to 4, the reflective sheet 30 is held together with the LED packages 20 in the holding region of the enclosure 10 such that part of the LED packages 20 is exposed (protrudes) through the exposure holes 33. Thus, the bottom surface 12 of the enclosure 10 and the mounting surface of the mounting board are covered with the bottom portion 31 of the reflective sheet 30, and the inside surface of the enclosure 10 is covered with the side portion 32 of the reflective sheet 30. Since the reflective sheet 30 is provided within the enclosure 10 in this way and thus light is reflected off the reflective sheet 30, the amount of light travelling toward a member to be illuminated is increased. Consequently, the efficiency of utilization of light is enhanced.

The lighting curtain 50 of the optical member 40 is attached to the opening portion of the enclosure 10 so as to block the opening 11. This lighting curtain 50 is attached to an area above the LED packages 20 so as to face the bottom surface 12 of the enclosure 10. Hence, when light is emitted from the LED packages 20, the light is incident on the lighting curtain 50. The lighting curtain 50 has the function of reducing variations in brightness by partially blocking the light from the LED packages 20.

In the first embodiment, the lighting curtain 50 is formed by providing a plurality of circular openings 52 in a plate-shaped member (reflective plate 51). Portions where the openings 52 are formed are transmission portions through which the light is transmitted; portions where the openings 52 are not provided are reflective portions off which the light is reflected. The openings 52 are distributed and arranged such that the openings 52 are not coupled to each other.

In the first embodiment, in order for the thickness of the light source module 100 to be reduced, the lighting curtain 50 is attached to a position at a height H1 (see FIG. 2) of, for example, about 3 mm from the bottom portion 12 (the bottom surface) of the enclosure 10.

In the LED packages 20 arranged within the enclosure 10, the center portion of the light emission surface thereof faces the member to be illuminated (the lighting curtain 50). Since the LED packages 20 emit light having a high intensity to an area directly above the LED packages 20, in the lighting curtain 50, a large amount of light is incident on the vicinity of the area directly above the LED packages 20 (an area including the area directly thereabove), and the amount of light is gradually decreased as the area on which light is incident is positioned farther away from the vicinity of the area directly thereabove. As described above, the intensity of light that is emitted from the LED packages 20 and that is then incident on the lighting curtain 50 differs depending on the portions of the lighting curtain 50. Hence, in the openings 52 of the lighting curtain 50, the aperture ratio is changed depending on portions where the openings 52 are formed, and the amount of light transmitted is adjusted by the openings 52. In other words, the sizes of the openings 52 (the areas of the openings) are not uniform, and are different depending on the positions where the openings 52 are arranged.

Specifically, the size of each of the openings 52 in the lighting curtain 50 is set such that, as the opening is positioned farther away from the vicinity of the area directly above the LED packages 20, its aperture ratio is gradually increased. In other words, the size of each of the openings 52 in the lighting curtain 50 is gradually increased as the opening is positioned farther away from the vicinity of the area directly above the LED packages 20. Furthermore, in the lighting curtain 50, portions to which a large amount of light is applied from the LED packages 20 (for example, the vicinity of the area directly above the LED packages 20) are not provided with the openings 52; the lighting curtain 50 is configured such that the light applied is reflected off those portions.

The distribution of the intensity of light that is incident on the lighting curtain 50 depends not only the light distribution characteristic of the LED packages 20 but also the shape, the size, the position of attachment and the like of the light source module (for example, the pitch of the LED packages 20 arranged and the space between the reflective sheet 30 and the lighting curtain 50). Hence, the openings 52 are formed such that a small amount of light passes through the portions of the lighting curtain 50 on which a large amount of light is incident. On the other hand, the openings 52 are formed such that a large amount of light passes through the portions of the lighting curtain 50 on which a small amount of light is incident.

The lighting curtain 50 is produced by forming, with press punching processing, a plurality of openings 52 in the reflective plate 51, for example, about 1 mm thick. The press punching processing is a production method that is effective for mass production because it has advantages over the running cost and the productivity. Instead of using the press punching processing, the process of the openings 52 can also be performed with means such as drilling processing or laser processing. The lighting curtain 50 can also be obtained such as by injection molding a resin having a high reflectance.

When a small amount of light is reflected off (a large amount of light is absorbed by) portions other than the openings 52 in the lighting curtain 50, even if variations in brightness is reduced, the brightness itself is reduced. Hence, the reflective plate 51 of the lighting curtain 50 is preferably formed of a reflective material having a high total reflectivity. Thus, the decrease in brightness is reduced. This type of material includes, for example, a slightly foamed PET (polyethylene terephthalate) resin. The reflective plate using a slightly foamed PET includes, for example, “MCPET” (registered trademark) made by Furukawa Electric Co., Ltd. The “MCPET” (registered trademark) made by Furukawa Electric Co., Ltd. is 1.0 mm thick and has a high total reflectivity (about 99%).

Here, in the first embodiment, the reflective sheet segments 60 that reflect the light are fixed to a predetermined region of the lighting curtain 50. As shown in FIGS. 1, 6 and 7, these reflective sheet segments 60 have a planar shape (a plane area) smaller than that of the lighting curtain 50.

The reflective sheet segments 60 are molded products that are obtained by processing the reflective sheet into a predetermined shape. As shown in FIGS. 2 and 5, the reflective sheet segments 60 are formed into the shape of a separate sheet, and are fixed to the lighting curtain 50 through an adhesion layer 80. Specifically, the reflective sheet segments 60 are fixed to the lighting curtain 50 with an adhesion material 80a of which the adhesion layer 80 is formed.

The reflective sheet segments 60 are attached to the portions of the lighting curtain 50 on which a large amount of light is incident. Then, by attaching the reflective sheet segments 60 to the lighting curtain 50, the light blocking ability of the lighting curtain 50 is partially enhanced.

As shown in FIGS. 5 to 7, in the first embodiment, each of the reflective sheet segments 60 is formed into a circular shape. As shown in FIGS. 1 and 2, the reflective sheet segments 60 are attached to the vicinity of the area directly above the LED packages 20 (the area including the area directly thereabove). The reflective sheet segments 60 are attached onto the surface (on the one surface) of the lighting curtain 50 on the side of the LED packages 20 such that the reflective sheet segments 60 are prevented from overlapping with the openings 52 of the lighting curtain 50. Specifically, the reflective sheet segments 60 are attached to areas which are in vicinity of the area directly above the LED packages 20 and in which the openings 52 are not fanned.

For example, the thickness of the reflective sheet segment 60 is preferably set at 50 μm to 400 μm, and is more preferably set at 100 μm to 200 μm. The thickness of the reflective sheet segments 60 differs depending on various conditions such as the material of the reflective sheet segments 60, the intensity of the light from the LED packages 20 and the distance from the LED packages 20 to the lighting curtain 50. Hence, the thickness of the reflective sheet segments 60 is preferably set at, in consideration of various conditions, a thickness having a predetermined characteristic.

The thickness of the reflective sheet segments 60 is preferably set smaller than that of the lighting curtain 50.

The reflective sheet of the reflective sheet segments 60 is not particularly limited; for example, a sheet formed of PET containing a reflective material, a sheet member onto which metal is evaporated or the like can be used.

Since the reflective sheet segments 60 are fixed with the adhesion material 80a to the lighting curtain 50, the adhesion layer 80 is present between the reflective sheet segments 60 and the lighting curtain 50. In this case, the light that has passed through the reflective sheet segments 60 reaches the adhesion layer 80 (the adhesion material 80a), and transmission and reflection are performed in the adhesion layer 80. Hence, since it is likely that the color of the adhesion layer 80 (the adhesion material 80a) affects the color of the resulting light, the adhesion layer 80 (the adhesion material 80a) is preferably white or transparent (colorless and transparent). The adhesion material 80a (the adhesion layer 80) is not particularly limited; for example, a milky white emulsion adhesive, a transparent epoxy adhesive or the like is preferably used. The adhesion material 80a (the adhesion layer 80) preferably has ultraviolet radiation resistance so that the change of its color and the decrease in its adhesion caused by ultraviolet radiation are reduced. This is easily achieved by using, for example, an adhesion material containing an ultraviolet absorption material. The adhesion material 80a (the adhesion layer 80) conceptually includes an adhesion material (adhesive layer).

The diffusion plate 70 is an optical sheet that overlaps the lighting curtain 50 and that diffuses the light received through the lighting curtain 50. The diffusion plate 70 is attached to an area above the lighting curtain 50 so as to block the opening 11 of the enclosure 10. The diffusion plate 70 is attached to a position at a height H2 of, for example, about 5 mm from the lighting curtain 50.

In the light source module 100 configured as described above and according to the first embodiment, when light is emitted from the LED packages 20, a large amount of light is incident on the vicinity of the area directly above the LED packages 20, but the amount of light that does not pass through the lighting curtain 50 and that is reflected toward the reflective sheet 30 is increased. On the other hand, in the portions other than the vicinity of the area directly above the LED packages 20 in the lighting curtain 50, as the portion is positioned farther away from the vicinity of the area directly thereabove, the amount of light incident thereon is reduced whereas, as the portion is positioned farther away from the vicinity of the area directly thereabove, the amount of light transmitted through the lighting curtain 50 (light passing through the openings 52) is gradually increased. Hence, the difference is reduced between the amount of light emitted from the vicinity of the area directly above the LED packages 20 in the lighting curtain 50 (the vicinity of the area directly thereabove including a portion directly thereabove and portions near the portion directly thereabove) and the amount of light emitted from portions separate from the vicinity of the area directly above the LED packages 20 in the lighting curtain 50. Thus, it is unlikely that variations in brightness are produced in planar light emitted from a predetermined surface (light-emitting surface) of the lighting curtain 50.

The planar light (the planar light that has had variations in brightness reduced) that has been emitted from the predetermined surface (light-emitting surface) of the lighting curtain 50 enters the diffusion plate 70. The planar light that has entered the diffusion plate 70 is further diffused and is emitted as planar light of high quality to the member to be illuminated.

As described above, since the directivity in the LED packages 20 toward the area directly thereabove (in the vertical direction) is high, a large amount of light is applied to the area directly above the LED packages 20 in the lighting curtain 50. In the first embodiment, since the reflective sheet segments 60 are attached to this area, the light blocking ability of this area is enhanced. In other words, in the first embodiment, in the lighting curtain 50 (the optical member 40), the light blocking ability of the area to which a large amount of light is applied is enhanced. Hence, even when the light blocking ability of the lighting curtain 50 is insufficient, the transmission of light through this area is reduced, with the result that variations in brightness are reduced.

The enhancement of the light blocking ability (the total light transmittance) of the area to which the reflective sheet segments 60 are attached will be simply calculated. For ease of calculation, the optical effects on the adhesion material 80a are ignored. The reflection of light is assumed to be all performed on the surface of a reflective material, and actions other than the reflection and the transmission of light are ignored. When it is assumed that the total light transmittance of the reflective sheet segments 60 is, for example, 5% and that the total light transmittance of the lighting curtain 50 is, for example, 1%, light that passes through both the reflective sheet segments 60 and the lighting curtain 50 is simply calculated to be 0.05%, with the result that the total light transmittance is extremely reduced to one-twentieth as compared with the case where only the lighting curtain 50 is used. Since the reflective sheet segments 60 are attached as described above, a high light blocking ability is achieved, and thus it is possible to effectively prevent variations in brightness even if a significant amount of light is applied to the predetermined area (small area).

Since the reflective sheet segments 60 are formed with the reflective sheet, they have the corresponding reflectivity. The light that has been reflected off the reflective sheet segments 60 is reflected several times off the reflective sheet 30, the lighting curtain 50 and the like, and then reaches the diffusion plate 70 through the openings 52 of the lighting curtain 50. Hence, much of light that cannot pass through the reflective sheet segments 60 and the lighting curtain 50 in the area directly above the LED packages 20 finally functions as the illumination light simply without loss thereof. Thus, the decrease in brightness is limited.

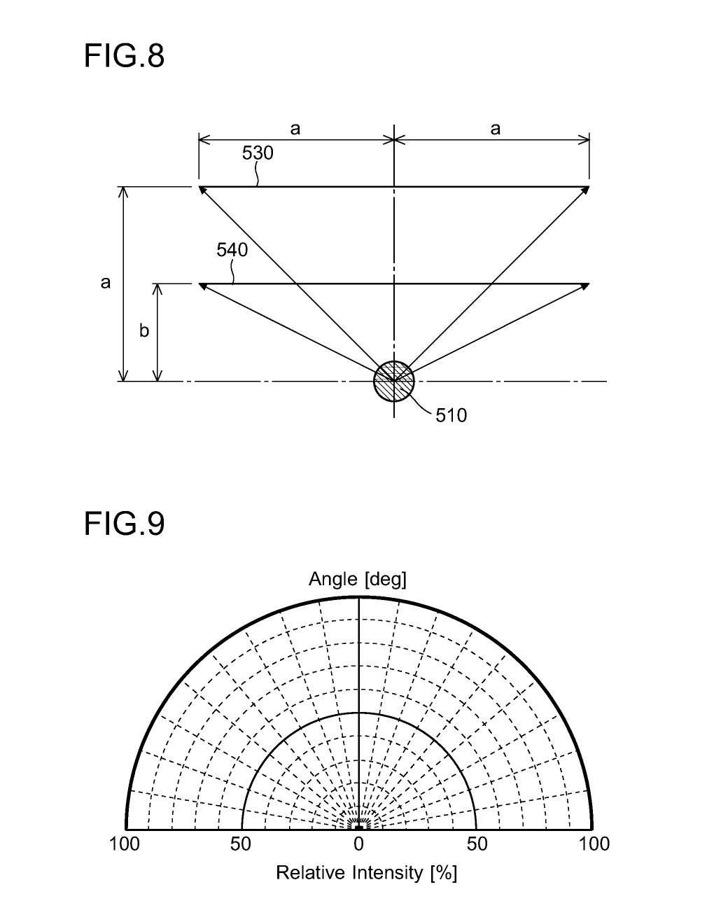

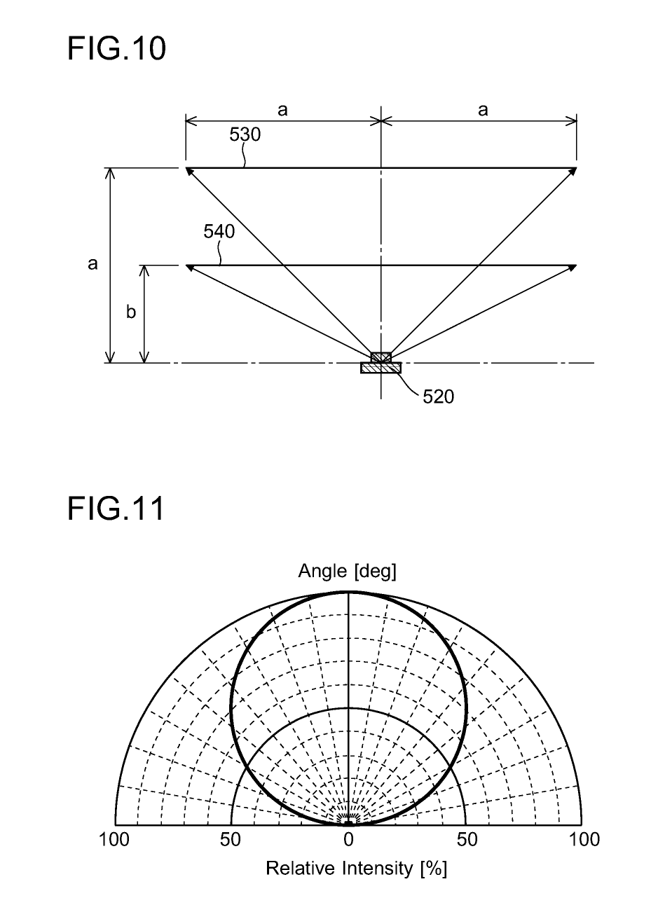

When the LED packages 20 are used as the light source, as compared with the case where a CCFL is used, a large amount of light is collected in the area directly above the light source. This tendency becomes greater as the thickness of the light source module is reduced. This point will be described in more detail with reference to FIGS. 8 to 11. FIGS. 8 and 9 are diagrams illustrating a light distribution characteristic when the CCFL is used as the light source. FIGS. 10 and 11 are diagrams illustrating a light distribution characteristic when the LED packages are used as the light source. FIGS. 9 and 11 are characteristic diagrams that indicate the intensity of light emitted at a certain angle as the relative intensity with respect to the case where the intensity of light emitted in the direction in which the maximum intensity is achieved is assumed to be 100%.

Since the CCFL that is conventionally used as the main light source is generally nondirectional, as shown in FIG. 9, its light distribution characteristic is of a line light source whose light distribution characteristic does not depend on the angle at which the light is emitted. When the light source is nondirectional, since the light is emitted at any angle such that the intensity is the same, the relative intensity is 100% even if the light is emitted at any angle. Here, for ease of description, consideration is given to only the components of light applied from the light source to the side of the lighting curtain 50.

For example, as shown in FIG. 8, on an illumination surface 530 a distance a (for example, 10 mm) away from the CCFL 510 that is the light source, light (since the CCFL 510 is a line light source, this application region is band-shaped) that is applied to positions within the distance a (for example, 10 mm) in the horizontal direction of the figure from the light source (the CCFL 510) is 25% of all light that has been applied. On an illumination surface 540 a distance b (for example, 5 mm) away from the light source, this is 35% of all light that has been applied.

A case where the LED packages are used as the light source will now be described. Although each of the LED packages has a unique light distribution characteristic, a case where the LED packages are a point light source having a light distribution characteristic corresponding to a Lambertian distribution and shown in FIG. 11 will be described here.

In the Lambertian distribution, when an angle with respect to the direction of the normal is assumed to be 0, the intensity of light emitted in the direction of the angle θ is proportional to cos θ. Hence, as compared with a nondirectional light source such as the CCFL, light is emitted such that the light is collected in the direction of the normal. In other words, the Lambertian distribution is the distribution of application of light that has a high directivity in the vertical direction.

As shown in FIG. 10, as in the case of the CCFL, on the illumination surface 530 the distance a (for example, 10 mm) away from a LED package 520 that is the light source, light (since the LED package 520 is a point light source, this application region is circular) that is applied to positions within the distance a (for example, 10 mm) in the horizontal direction of the figure from the light source (the LED package 520) is 50% of all light that has been applied. On the illumination surface 540 the distance b (for example, 5 mm) away from the light source, this is 80% of all light that has been applied.

As described above, when a light source such as the LED packages is used in which the directivity in the vertical direction (toward the area directly thereabove) is high, a large amount of light is collected in the area directly above the light source, and this tendency becomes greater as the thickness of the light source module is reduced. Hence, when the LED packages are used as the light source, if the thickness of the light source module is reduced, a large amount of light is applied remarkably to a specific portion of the lighting curtain. Thus, it is very difficult to reduce the thickness of the light source module while reducing variations in brightness.

However, since, as described above, the light source module 100 of the first embodiment includes the optical member 40 in which the reflective sheet segments 60 are attached to the lighting curtain 50, and thereby has a sufficient light blocking ability, even when a large amount of light is applied remarkably to a specific portion of the lighting curtain 50, variations in brightness are reduced. Thus, it is possible to reduce the thickness of the light source module 100 while reducing variations in brightness.

With the reflective sheet segments 60 attached to the lighting curtain 50, the lighting curtain 50 is subjected to the assembly of the light source module 100. Hence, in the assembly of the light source module 100, the lighting curtain 50 (the optical member 40) can be attached in a step similar to the conventional step. Hence, the number of assembly steps, the throughput, the cost and the like are equivalent to those in the conventional case. It is possible to easily attach the reflective sheet segments 60 by, for example, attaching a plurality of reflective sheet segments 60 at a time.

In the first embodiment, as described above, when the reflective sheet segments 60 are attached to the lighting curtain 50 and thus a large amount of light is applied from the light source (the LED packages 20) to an area of the lighting curtain 50, the light can be blocked both by the reflective sheet segments 60 and by the lighting curtain 50. Hence, since a sufficient light blocking ability can be obtained, even when a large amount of light is applied remarkably to a specific portion of the lighting curtain 50, the light can be sufficiently blocked. Thus, it is possible to make it unlikely that, even when a light source such as the LED packages 20 having a high directivity is used or even when the thickness of the module is reduced, variations in the brightness of the light (illumination light) that is emitted through the lighting curtain 50 are produced.

Moreover, in the first embodiment, the reflective sheet segments 60 are configured to have a planar shape (a plane area) smaller than that of the lighting curtain 50, and thus it is possible to provide the reflective sheet segments 60 in only an area to which a large amount of light is applied from the light source (the LED packages 20). Thus, it is possible to reduce the increases in the material cost, the weight and the like as compared with the case where, in order for the light blocking ability of the lighting curtain 50 to be enhanced, the thickness of the lighting curtain is increased or a plurality of lighting curtains are stacked. When the reflective sheet segments 60 are provided in the lighting curtain 50, the thickness of the lighting curtain itself is not increased. Hence, it is also possible to prevent the thickness of the light source module 100 from being increased due to the increase in the thickness of the lighting curtain 50.

As described above, in the first embodiment, even when the light source having a high directivity is used, it is possible to reduce the thickness of the light source module 100. Even in the configuration described above, it is possible to emit uniform illumination light having variations in brightness reduced.

Furthermore, in the first embodiment, in the configuration described above, it is possible to enhance the light blocking ability without the use of a plurality of lighting curtains. Thus, it is possible to prevent disadvantages produced when a plurality of lighting curtains are used. For example, it is possible to eliminate the need to give consideration to the attachment of a plurality of lighting curtains and the positioning of the lighting curtains when the light source module 100 is assembled. Consequently, it is possible to, for example, enhance the accuracy of attachment of the lighting curtain, reduce the cost in the attachment step and enhance the throughput in the attachment step.

Since, in the first embodiment, as the lighting curtain 50, the lighting curtain formed with the reflective plate 51 including the transmission portions produced by the openings 52 is used, the reflective sheet segments 60 are provided in the lighting curtain 50, and thus it is possible to acquire the light source module 100 that can easily and uniformly illuminate the member to be illuminated.

As shown in FIG. 3, for example, the light source module 100 described above can be used as a backlight unit 100 (a direct-type backlight unit) of a liquid crystal display device 300.

This liquid crystal display device 300 includes; a liquid crystal display panel 200 (the member to be illuminated); and the backlight unit 100 (the light source module 100) that provides light to the liquid crystal display panel 200. For example, the liquid crystal display panel 200 is configured by adhering, with a seal material (unillustrated), an active matrix substrate 201 including switching elements such as a TFT (thin film transistor) to an opposite substrate 202 opposite the active matrix substrate 201. Liquid crystal (unillustrated) is injected into a space between both the substrates 201 and 202. A polarization film 203 is attached to each of the side of the light receiving surface of the active matrix substrate 201 and the side of the light emitting surface of the opposite substrate 202.

The liquid crystal display panel 200 configured as described above utilizes changes in transmittance due to the inclination of the molecules of the liquid crystal, and thereby displays an image. Since, as the backlight 100 illuminating the liquid crystal display panel 200, the light source module 100 is used, it is possible to provide the liquid crystal display device 300 which has an excellent display function and whose thickness is thin

### Second Embodiment

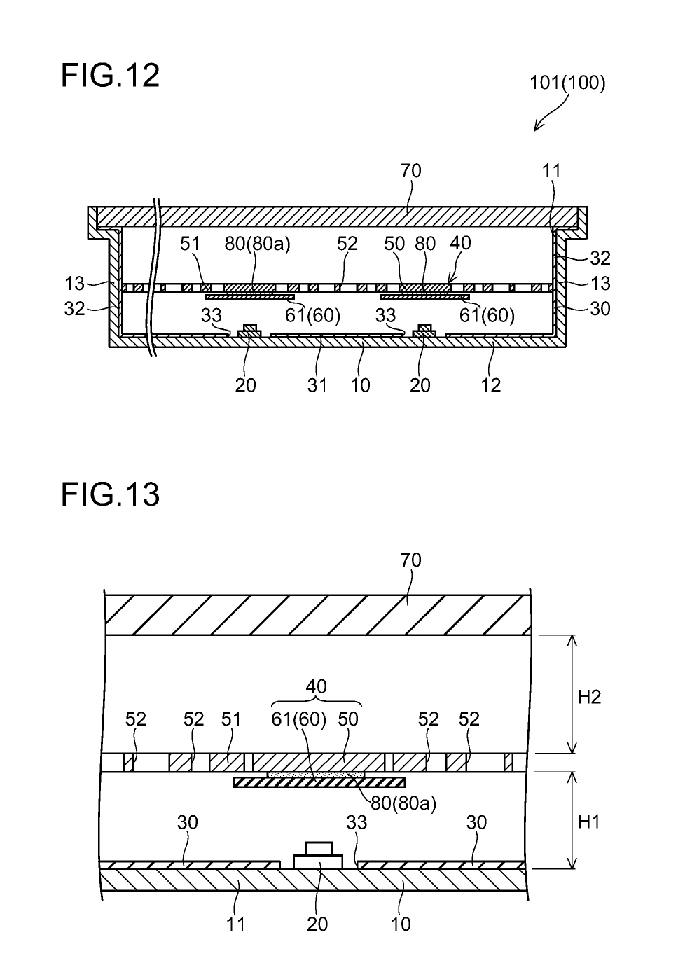

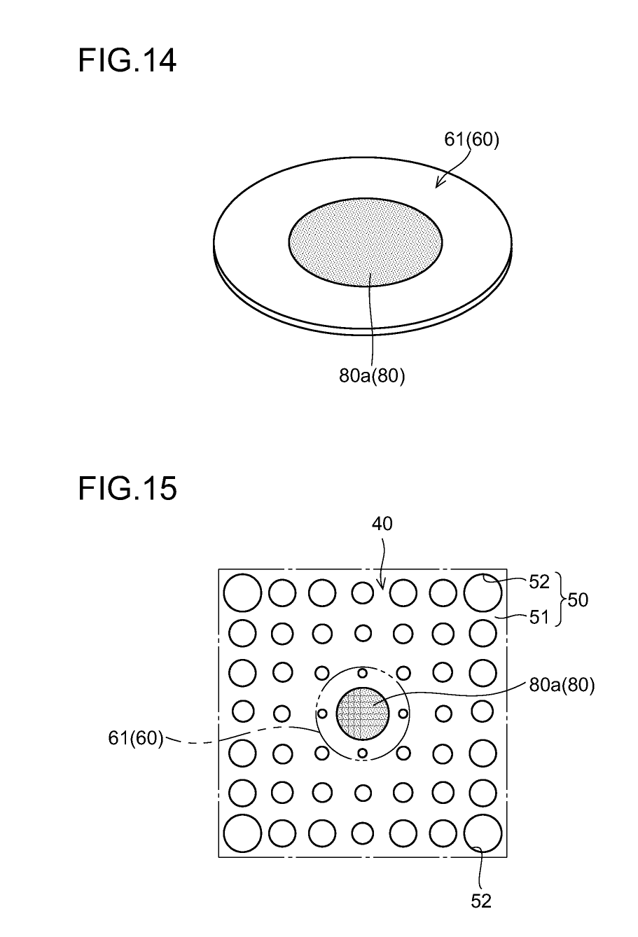

FIG. 12 is a cross-sectional view of a light source module according to a second embodiment of the present invention; FIG. 13 is a cross-sectional view showing an enlarged portion of FIG. 12. FIG. 14 is a perspective view of a reflective sheet segment of the light source module according to the second embodiment of the present invention; FIG. 15 is a plan view showing a portion of a lighting curtain in the light source module according to the second embodiment of the present invention. The light source module according to the second embodiment of the present invention will now be described with reference to FIGS. 12 to 15. In the drawings, the corresponding constituent components are identified with common symbols, and therefore their description will not be repeated as appropriate.

As shown in FIGS. 12 and 13, in the light source module 101 (100) of the second embodiment, the reflective sheet segments 61 (60) are configured to cover at least part of the openings 52 of the lighting curtain 50. In other words, in the second embodiment, the reflective sheet segments 61 are attached to the lighting curtain 50 such that the reflective sheet segments 61 covers at least part of the openings 52 of the lighting curtain 50.

In portions (portions covered by the reflective sheet segments 61) of a plurality of openings 52 provided in the lighting curtain 50 that are covered by the reflective sheet segments 61, light is blocked by only the reflective sheet segments 61. Hence, in these portions, the total light transmittance is low as compared with the openings 52, and the total light transmittance is high as compared with portions (areas) in which light is blocked by both the reflective sheet segments 61 and the lighting curtain 50. Therefore, the portions in which the openings 52 are covered by the reflective sheet segments 61 have an intermediate total light transmittance.

When the adhesion material 80a (see FIG. 14) is applied to the entire surface of the reflective sheet segments 61, the openings 52 of the lighting curtain 50 may be blocked by the adhesion material 80a (the adhesion layer 80). Hence, in the second embodiment, the adhesion material 80a (the adhesion layer 80) is preferably applied (formed) to areas other than the openings 52 of the lighting curtain 50. In this case, by applying the adhesion material 80a with a printing method such as silk printing, it is possible to accurately and easily apply (form) the adhesion material 80a (the adhesion layer 80) to a predetermined area.

When the adhesion material 80a is applied with the printing method, as shown in FIG. 14, the adhesion material 80a (the adhesion layer 80) may be applied (formed) to the reflective sheet segments 61 whereas, as shown in FIG. 15, the adhesion material 80a (the adhesion layer 80) may be applied (formed) to the predetermined area of the lighting curtain 50. The adhesion material 80a (the adhesion layer 80) may be applied (formed) to both the reflective sheet segments 61 and the lighting curtain 50.

The configuration of the other portions in the second embodiment is the same as in the first embodiment.

In the second embodiment, as described above, at least part of the openings 52 of the lighting curtain 50 is covered by the reflective sheet segments 61, and thus it is possible to form, for example, an area which has an intermediate light blocking ability, that is, in which the light is transmitted through the lighting curtain 50 but is reflected off the reflective sheet segments 61. Thus, the flexibility of the design of the light source module can be enhanced. The flexibility of the design of a pattern (an opening pattern) of transmittances in the lighting curtain 50 can also be enhanced.

The configuration described above is utilized in portions that are originally required to have minute openings 52 in the lighting curtain 50, and thus it is possible to increase the opening size. When the opening size is increased, the openings 52 are covered by the reflective sheet segments 61, and thus it is possible to acquire a light blocking ability equivalent to that of the original opening size. In this way, it is possible to easily and inexpensively form the openings 52 in the production step of the lighting curtain 50.

Even when, for example, the dimension of a portion of the openings 52 is so small as to have difficulty producing the lighting curtain 50 by injection molding, it is likely that the production can be performed by increasing the size of the openings 52. Even when the openings 52 are formed with press punching processing, the processing is likely to be difficult to perform if the dimension of the openings 52 is small; however, it is likely that the production can be performed by increasing the size of the openings 52. Furthermore, when the dimension is large, the tolerance of the dimension can be generally increased, with the result that the quality and the yield are enhanced.

For example, when a design failure or the like occurs and thus the openings 52 of the lighting curtain 50 are larger than those of a proper size or when unnecessary openings 52 are provided, it is also possible to cover the openings 52 with the reflective sheet segments 61 in order to perform correction. It is also possible to use the configuration described above so that an opening for positioning the reflective sheet segments 61 is formed in the lighting curtain 50, and that, when the reflective sheet segments 61 are attached, the reflective sheet segments 61 are positioned or whether or not the proper positioning is performed is checked.

The other effects of the second embodiment are the same as those of the first embodiment.

### Third Embodiment

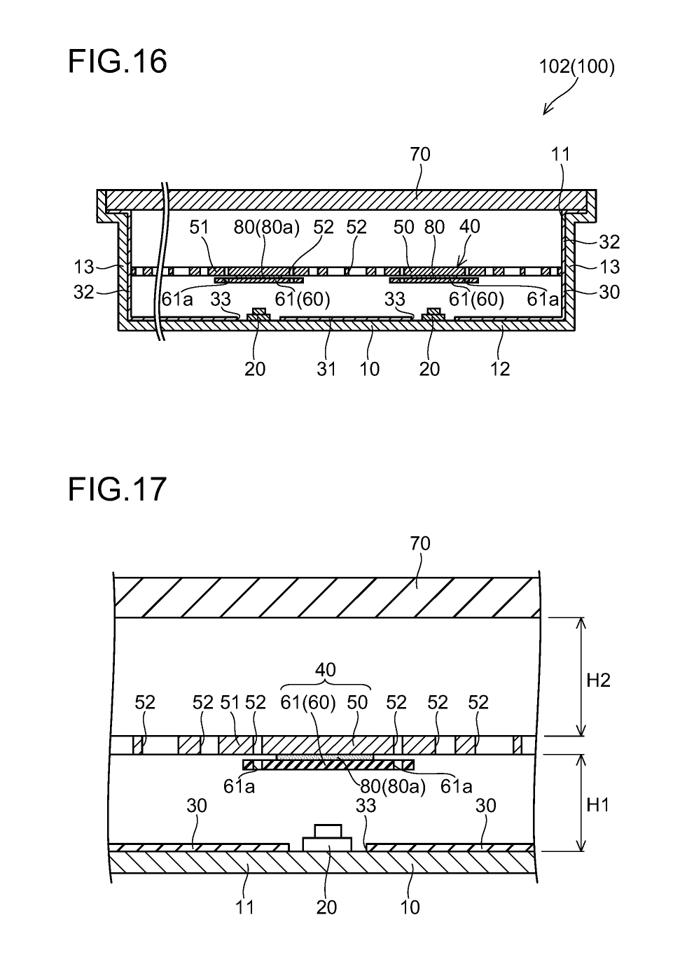

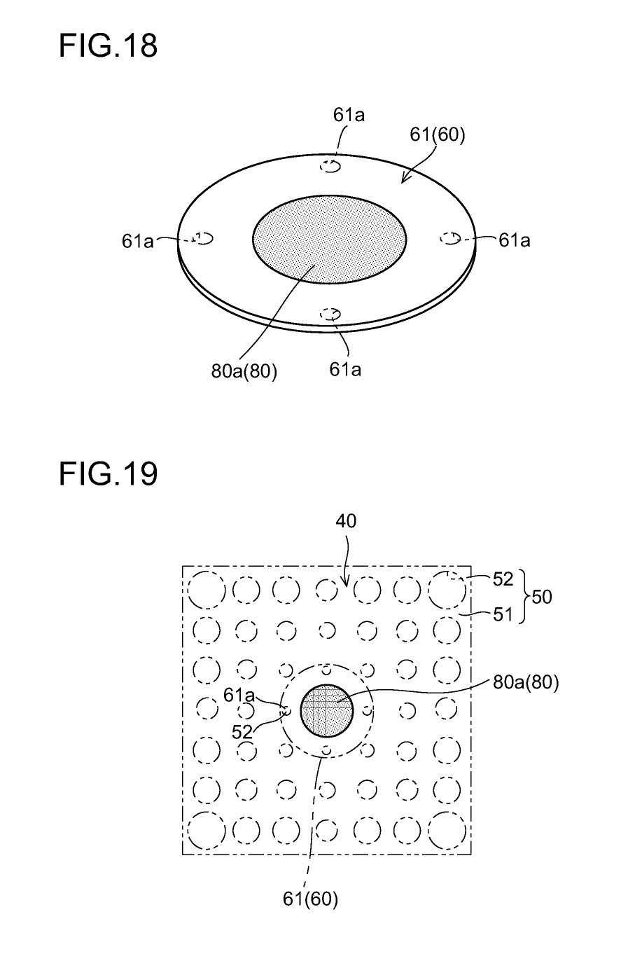

FIG. 16 is a cross-sectional view of a light source module according to a third embodiment of the present invention; FIG. 17 is a cross-sectional view showing an enlarged portion of FIG. 16. FIG. 18 is a perspective view of a reflective sheet segment of the light source module according to the third embodiment of the present invention; FIG. 19 is a plan view showing a portion of a lighting curtain in the light source module according to the third embodiment of the present invention. The light source module according to the third embodiment of the present invention will now be described with reference to FIGS. 16 to 19. In the drawings, the corresponding constituent components are identified with common symbols, and therefore their description will not be repeated as appropriate.

As shown in FIGS. 16 and 17, in the light source module 102 (100) of the third embodiment, opening holes 61a common to the lighting curtain 50 are formed in part of the reflective sheet segments 61 (60). In other words, in the third embodiment, the opening holes 61a are provided in the reflective sheet segments 61 so as to cover the openings 52 of the lighting curtain 50. Thus, portions (reflective portions) in which the reflective sheet segments 61 are provided and which have a high light blocking ability can be made adjacent to the openings 52. Consequently, the light blocking ability can be enhanced in the vicinity of the openings 52.

The provision of the openings of the same shape in the lighting curtain 50 and the reflective sheet segments 61 can be easily and highly accurately performed by, for example, adhering the reflective sheet segments 61 to the lighting curtain 50 and then conducing press punching processing or the like. Preferably, as shown in FIG. 17, in order for the processing to be more easily performed, the adhesion material 80a (the adhesion layer 80) is not present in portions where the openings are formed and in the vicinity thereof. If the adhesion material 80a (the adhesion layer 80) is present in these portions, the adhesion material is disadvantageously adhered to a mold used when the press punching processing is performed. The adhesion material of indefinite shape is also disadvantageously adhered to the vicinity of the openings. On the other hand, in the configuration described above, these disadvantages can be eliminated.

When the adhesion layer 80 (the adhesion material 80a) is provided in the areas (the areas other than the opening holes 61a) other than the portions where the openings are formed and the vicinity thereof, the adhesion material 80a is applied with a printing method such as silk printing, and thus it is possible to accurately and easily apply (form) the adhesion material 80a (the adhesion layer 80) to the predetermined area.

When the adhesion material 80a is applied with the printing method, as shown in FIG. 18, the adhesion material 80a (the adhesion layer 80) may be applied (formed) to the reflective sheet segments 61 or, as shown in FIG. 19, the adhesion material 80a (the adhesion layer 80) may be applied (formed) to the predetermined area of the lighting curtain 50. The adhesion material 80a (the adhesion layer 80) may be applied (formed) to both the reflective sheet segments 61 and the lighting curtain 50.

Since the reflective sheet segments 61 are adhered to an area of the lighting curtain 50, the entire thickness of the lighting curtain 50 is prevented from being increased. In other words, the area whose thickness is increased by the provision of the reflective sheet segments 61 is limited. Hence, even when the openings are formed, with the press punching processing, in the lighting curtain 50 and the reflective sheet segments 61, as compared with the case where the openings are formed in the lighting curtain having a large thickness, a low stress (load) is applied to a press, with the result that the processing of the openings is easily performed.

The configuration of the other portions in the third embodiment and the other effects of the third embodiment are the same as those of the first and second embodiments.

### Fourth Embodiment

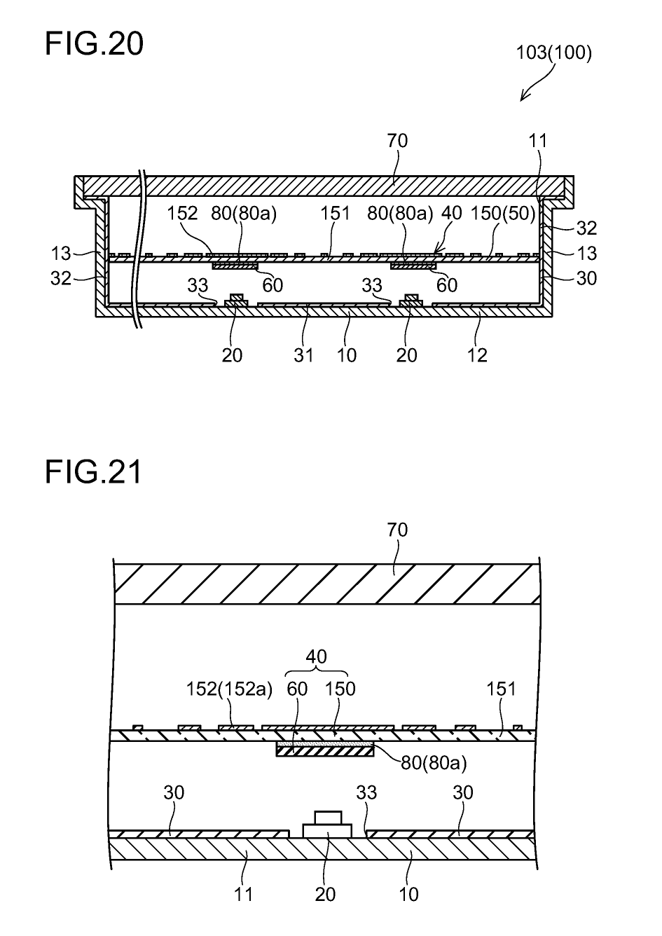

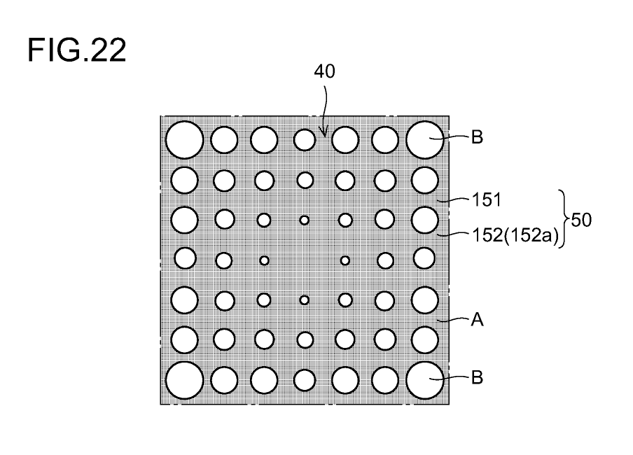

FIG. 20 is a cross-sectional view of a light source module according to a fourth embodiment of the present invention. FIG. 21 is a cross-sectional view showing an enlarged portion of FIG. 20. FIG. 22 is a plan view showing a portion of a lighting curtain in the light source module according to the fourth embodiment of the present invention. The light source module according to the fourth embodiment of the present invention will now be described with reference to FIGS. 20 to 22. In the drawings, the corresponding constituent components are identified with common symbols, and therefore their description will not be repeated as appropriate.

The light source module 103 (100) of the fourth embodiment differs from those of the first to third embodiments in the configuration of the lighting curtain. Specifically, in the fourth embodiment, as shown in FIGS. 20 and 21, the lighting curtain 150 that is formed by applying a reflective material 152 to a transparent plate 151 is provided. More specifically, the lighting curtain 150 is formed by, for example, applying an ink (the reflective material 152), such as a white ink or a metallic ink, which has a low total light transmittance to the transparent plate 151 made of polycarbonate. The transparent plate 151 is an example of a “plate-shaped member” of the present invention.

A printing method can be used to apply the reflective material 152. As described above, the method of printing the reflective material 152 has advantages in that the unit price and the initial cost are inexpensive and the productivity is high. Since, with the printing method, a minute pattern or a shape (for example, a collection of a large number of dots) that is difficult to realize with another molding method can easily be realized, the flexibility of the design is advantageously high.

The printing of the reflective material 152 is preferably performed by silk printing. Instead of silk printing, an inkjet method, an offset method or the like may be used.

On a portion of the lighting curtain 150 to which a large amount of light is incident, the reflective material 152 is printed such that the amount of light transmitted is reduced. On the other hand, on a portion of the lighting curtain 150 to which a small amount of light is incident, the reflective material 152 for increasing the amount of light transmitted is printed. For example, the reflective material 152 is printed on the transparent plate 151 in a pattern shown in FIG. 22. In FIG. 22, a portion on which the reflective material 152 is printed is referred as a reflective portion A (light blocking portion) that reflects light, and a portion on which the reflective material 152 is not printed is referred as a transmission portion B that transmits light. In other words, the transparent plate 151 transmits light, but a large part of light that is applied to the reflective material 152 is reflected off the reflective material 152. Hence, the transmission portion B and the reflection portion A (light blocking portion) are formed by the printing of the reflective material 152. Thus, the lighting curtain 150 according to the fourth embodiment also has the same function as the lighting curtain shown in the first to third embodiments.

As shown in FIG. 21, on the area (the area to which a large amount of light is applied from the light source) that is required to have a high light blocking ability, the reflective material 152 is applied to the transparent plate 151, and the reflective sheet segments 60 are adhered.

As in the first embodiment, the enhancement of the light blocking ability (the total light transmittance) of the area to which the reflective sheet segments 60 are attached will be simply calculated. For ease of calculation, the optical effects on the adhesion material 80a are ignored. The reflection of light is assumed to be all performed on the surface of the reflective material, and actions other than the reflection and the transmission of light are ignored. When it is assumed that the total light transmittance of the reflective sheet segments 60 is, for example, 5% and that the total light transmittance of the reflective material 152 is, for example, 10%, light that passes through both the reflective sheet segments 60 and the reflective material 152 is simply calculated to be 0.5%, with the result that the light blocking ability is high as compared with the case where either the reflective material 152 or the reflective sheet segments 60 alone is used.

In general, although the method of forming the lighting curtain by printing is inexpensive, the total light transmittance tends to be high. However, the reflective sheet segments 60 are provided in portions that have an insufficient light blocking ability, and thus it is possible to supplement, with the reflective sheet segments 60, the light blocking ability of those portions. In this way, even when the lighting curtain 150 formed with the printing method is used, it is possible to acquire a sufficient light blocking ability.

In the fourth embodiment, as an example, a case where the reflective material 152 is printed on the upper surface (the surface opposite the surface on which the reflective sheet segments 60 are provided) of the transparent plate 151 is described. A print layer 152a that is formed with the reflective material 152 is formed on the transparent plate 151 by the printing of the reflective material 152.

### Fifth Embodiment

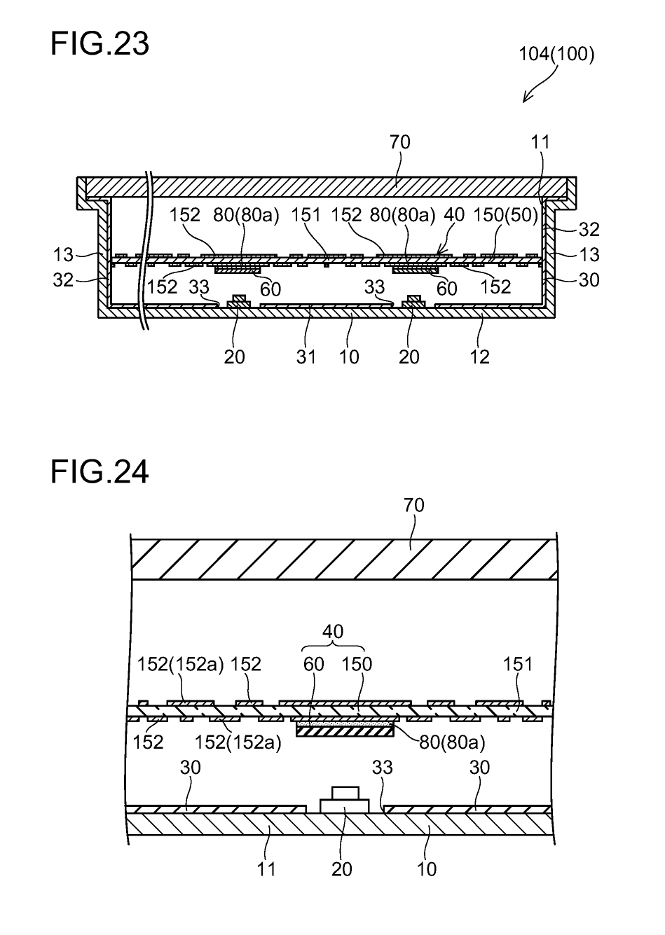

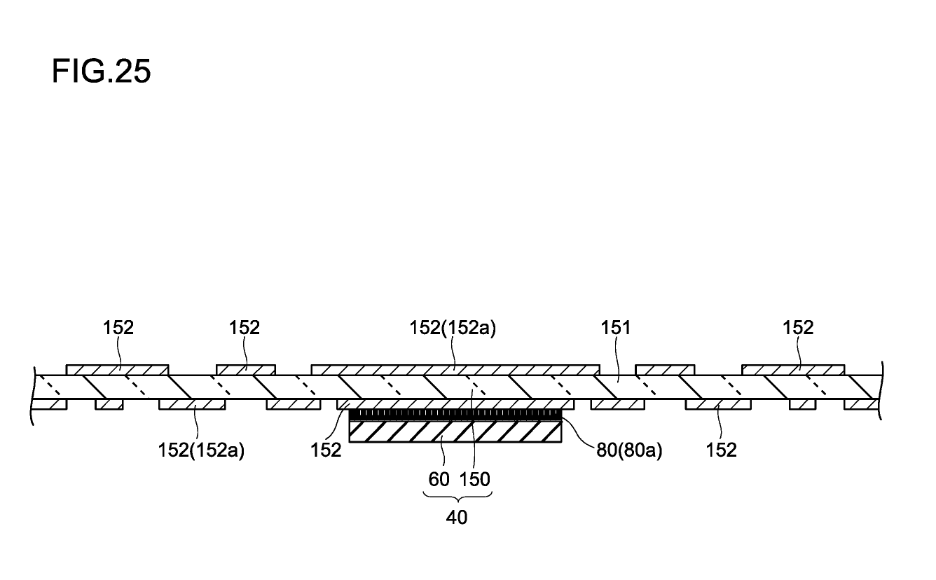

FIG. 23 is a cross-sectional view of a light source module according to a fifth embodiment of the present invention. FIG. 24 is a cross-sectional view showing an enlarged portion of FIG. 20. FIG. 25 is a cross-sectional view showing an enlarged portion of a lighting curtain in the light source module according to the fifth embodiment of the present invention. The light source module according to the fifth embodiment of the present invention will now be described with reference to FIGS. 23 to 25. In the drawings, the corresponding constituent components are identified with common symbols, and therefore their description will not be repeated as appropriate.

In the light source module 104 (100) of the fifth embodiment, as shown in FIGS. 23 to 25, the reflective material 152 is applied (printed) to both surfaces of the transparent plate 151 of the lighting curtain 150. Hence, the print layer 152a is formed, by the printing of the reflective material 152, on each of the upper and lower surfaces of the transparent plate 151.

Here, when light having a certain degree or more of intensity is not reflected off the lighting curtain 150 and the reflective sheet segments 60, and is directly emitted from the light emitting surface, this may cause variations in brightness. Preferably, with respect to the light having a certain degree or more of intensity, the printing pattern of the reflective material 152 (the print layer 152a) and the shape and the position of the reflective sheet segments 60 are set such that the light is reflected off the reflective material 152 (the print layer 152a) printed on either surface of the transparent plate 151 or the reflective sheet segments 60 and is then emitted.

Specifically, each printing pattern of the reflective material 152 is preferably formed such that, on an area (the area to which light having a certain degree of intensity is applied) at least a relatively short distance away from the area directly above the LED packages 20 (the vicinity of the area directly thereabove), the light from the LED packages 20 is applied to the reflective material 152 (the print layer 152a) which is printed (applied) on at least one surface. In other words, the reflective material 152 (the print layer 152a) is preferably formed such that the light from the LED packages 20 does not passes through the lighting curtain 150 without being applied to the reflective material 152 (the print layer 152a).

For example, as shown in FIG. 25, each printing pattern is formed such that a portion (area) of one surface (for example, the upper surface) of the transparent plate 151 on which the reflective material 152 (the print layer 152a) is not formed is covered with the reflective material 152 (the print layer 152a) on the other surface (for example, the lower surface).

In the configuration described above, the light generated from the light source (the LED packages 20) is applied to any one of the reflective material 152, the reflective sheet 30 in the vicinity thereof and the like without fail. Then, the light reaches the light emitting surface only after being subjected to reflection and transmission. Thus, variations in brightness resulting from high-intensity light being directly emitted are reduced. By providing the reflective sheet segments 60 in the area directly thereabove (the area in which the light blocking ability needs to be enhanced), it is possible to sufficiently enhance the light blocking ability of the area.

The configuration of the other portions in the fifth embodiment is the same as that of the fourth embodiment. The other effects of the fifth embodiment are the same as those of the first to fourth embodiments.

### Sixth Embodiment

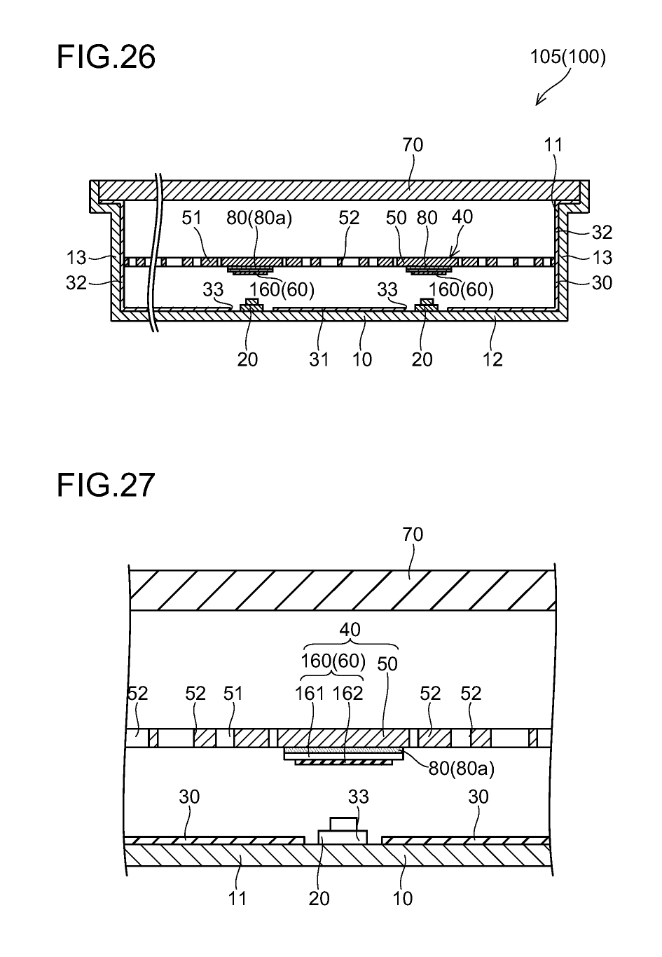

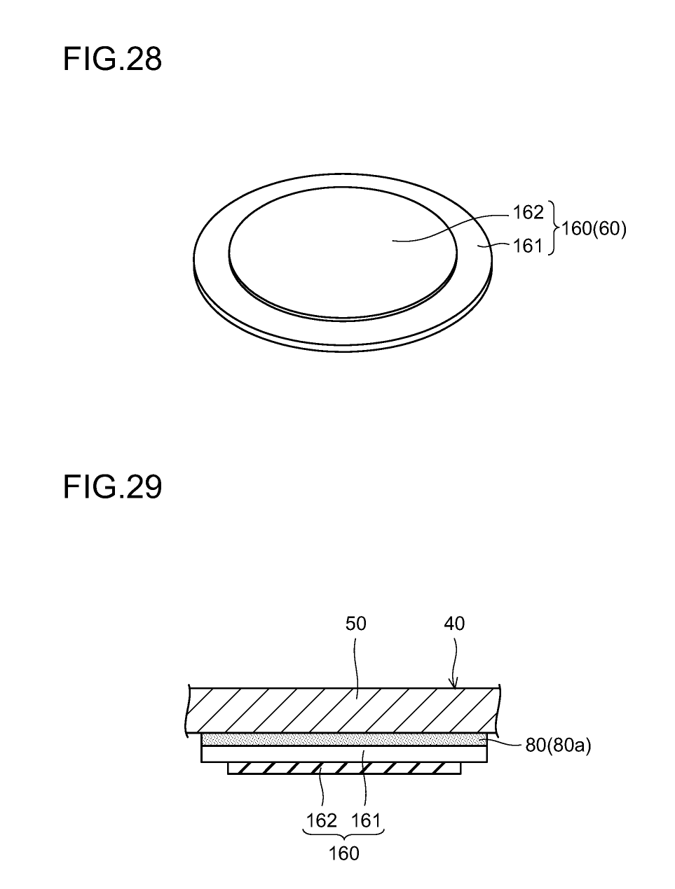

FIG. 26 is a cross-sectional view of a light source module according to a sixth embodiment of the present invention; FIG. 27 is a cross-sectional view showing an enlarged portion of FIG. 26. FIG. 28 is a perspective view showing a reflective sheet segment of the light source module according to the sixth embodiment of the present invention; FIG. 29 is a cross-sectional view showing a state where the reflective sheet segment is attached in the sixth embodiment of the present invention. The light source module according to the sixth embodiment of the present invention will now be described with reference to FIGS. 26 to 28. In the drawings, the corresponding constituent components are identified with common symbols, and therefore their description will not be repeated as appropriate.

The light source module 105 (100) of the sixth embodiment differs from that of the first embodiment in the configuration of the reflective sheet segment. Specifically, in the sixth embodiment, as shown in FIGS. 26 to 29, the reflective sheet segment 160 (60) is formed by printing (applying) a reflective material 162 on a base material 161. In other words, the reflective sheet segment 160 of the sixth embodiment is formed with a reflective member (a first reflective member) in which the reflective material 162 is formed on the base material 161.

Since the reflective sheet segment described in the first embodiment is formed by processing the reflective sheet into a specific shape, if a complicated shape or a fine shape is required, it is necessary to process the reflective sheet complicatedly and finely. By contrast, in the sixth embodiment, since the reflective material 162 is printed on the base material 161 and thus the reflective sheet segment 160 is formed, it is possible to form, by printing, an area (shape) in which the light blocking characteristic needs to be enhanced. Hence, since the flexibility of the design is significantly high, it is possible to easily form even a complicated shape or a fine shape.

The configuration of the other portions in the sixth embodiment is the same as that of the first embodiment.

In the sixth embodiment, as described above, the reflective sheet segment 160 is formed with the reflective member in which the reflective material 162 is printed on the base material 161, and thus it is possible to form the light reflecting area (a reflective area on which the reflective material 162 is printed) into a complicated pattern or a fine pattern. Hence, since the reflective material 162 can be accurately applied to the area in which the light blocking characteristic needs to be enhanced, it is possible to easily enhance the light blocking characteristic of the area.

As the base material 161 of the reflective sheet segment 160, for example, a transparent polycarbonate plate can be used. By using the polycarbonate plate as the base material 161, it is possible for a transparent portion to have a sufficient transmittance. As the reflective material 162, for example, a white ink or a metallic ink can be used.

The base material 161 described above can also be formed with the reflective sheet. Specifically, the reflective sheet segment 160 described above can also be formed with a reflective member (a second reflective member) in which the reflective material 162 is further printed on the reflective sheet (the base material 161). In the configuration described above, since the reflective sheet segment 160 is formed with the reflective sheet and the reflective material 162 that is printed thereon, the reflective sheet segment 160 is formed with a plurality of layers. Thus, since the reflecting ability of the reflective sheet segment 160 can be further enhanced, it is possible to further enhance the light blocking ability of the lighting curtain 50 in which the reflective sheet segments 160 are provided.

The other effects of the sixth embodiment are the same as those of the first embodiment.

### Seventh Embodiment

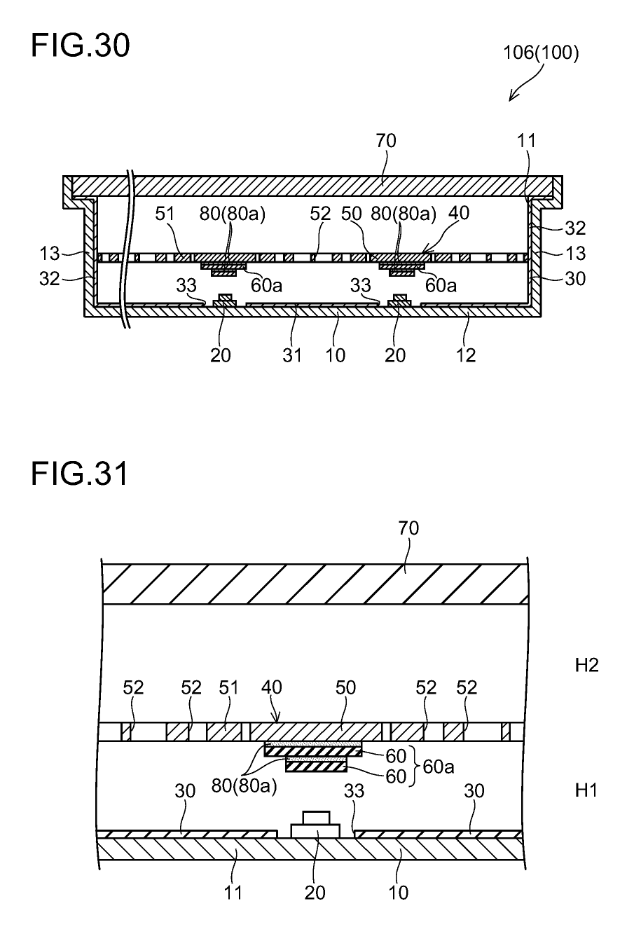

FIG. 30 is a cross-sectional view of a light source module according to a seventh embodiment of the present invention. FIG. 31 is a cross-sectional view showing an enlarged portion of FIG. 30. The light source module according to the seventh embodiment of the present invention will now be described with reference to FIGS. 30 and 31. In the drawings, the corresponding constituent components are identified with common symbols, and therefore their description will not be repeated as appropriate.

In the light source module 106 (100) of the seventh embodiment, as shown in FIGS. 30 and 31, the reflective sheet segment 60 is attached to the lighting curtain 50 with the adhesion material 80a, and another reflective sheet segment 60 is further attached to the reflective sheet segment 60 with the adhesion material 80a. In other words, in the seventh embodiment, a plurality of reflective sheet segments are stacked by being attached to each other. Hence, the reflective sheet segment 60a of the seventh embodiment is configured to include a first reflective sheet segment 60 (a first reflective layer) that is attached directly to the lighting curtain 50 and a second reflective sheet segment 60 (a second reflective layer) that is attached to this reflective sheet segment 60.

The configuration of the other portions in the seventh embodiment is the same as in the first embodiment.

In the seventh embodiment, the reflective sheet segment 60a is configured as described above, and thus it is possible to cope with a case where an extremely high light blocking ability is required or a case where the reflective sheet segment 60 is formed with a material having a relatively low light blocking ability.

The other effects of the seventh embodiment are the same as those of the first embodiment.

### Eighth Embodiment

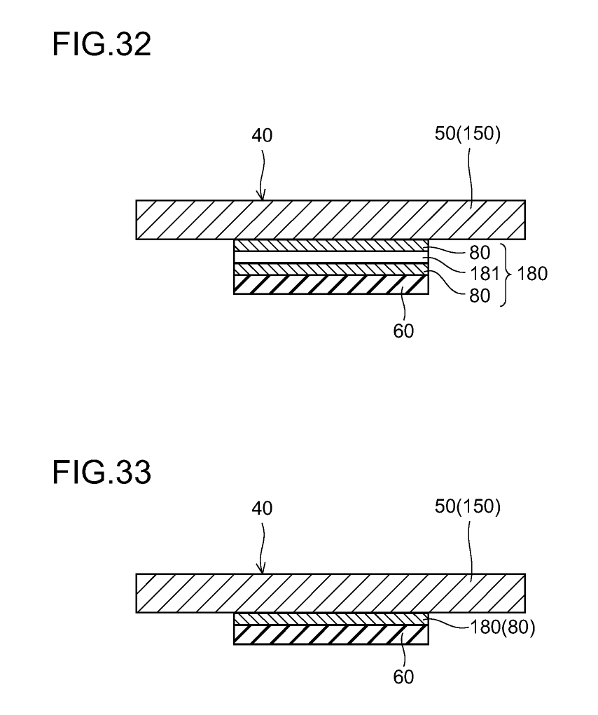

FIG. 32 is a cross-sectional view showing a portion of an optical member of a light source module according to an eighth embodiment of the present invention. FIG. 33 is a cross-sectional view showing a portion (another example) of the optical member of the light source module according to the eighth embodiment of the present invention. The light source module according to the eighth embodiment of the present invention will now be described with reference to FIGS. 32 and 33. In the drawings, the corresponding constituent components are identified with common symbols, and therefore their description will not be repeated as appropriate.

The eighth embodiment differs from the first to seventh embodiments in that the reflective sheet segment 60 is attached to the lighting curtain 50 (150) with a double-faced tape 180. As shown in FIG. 32, the double-faced tape 180 is formed with a base material 181 and adhesion layers 80 (adhesion material) that are applied to both surfaces of the base material 181.

As described above, it is also possible to use the double-faced tape 180 to attach the reflective sheet segment 60. However, when the double-faced tape 180 is used, light that has passed through the reflective sheet segment 60 is applied to the adhesion layer 80 (adhesion material), and the light that has passed through it is further applied to the base material 181. Then, this light is repeatedly subjected to transmission and reflection, and is thereafter emitted to the outside. Hence, when the double-faced tape 180 is used, not only the adhesion layer 80 (adhesion material) but also the base material 181 may optically affect the application of light from the light source module. Therefore, when the double-faced tape 180 is used to attach the reflective sheet segment 60, not only the adhesion layer 80 (adhesion material) but also the base material 181 is preferably white or transparent (colorless and transparent). An example of this type of double-faced tape is a double-faced tape that uses PET or PMMA as the base material 181.

As shown in FIG. 33, a board-free double-faced tape 180 can also be used to attach the reflective sheet segment 60. This type of board-free double-faced tape 180 is used, and thus it is unnecessary to give consideration to the effects of the base material, with the result that it is more preferable to use it. This case is the same as the case where, as described in the first embodiment, the reflective sheet segment 60 is attached with the adhesion material.

Even when the double-faced tape is used, the adhesion layer (adhesion material) is affected by the light from the light source. Hence, even in the double-faced tape, the adhesion layer (adhesion material) preferably has ultraviolet radiation resistance. This is easily achieved by using an adhesion material containing an ultraviolet absorption material.

### Ninth Embodiment

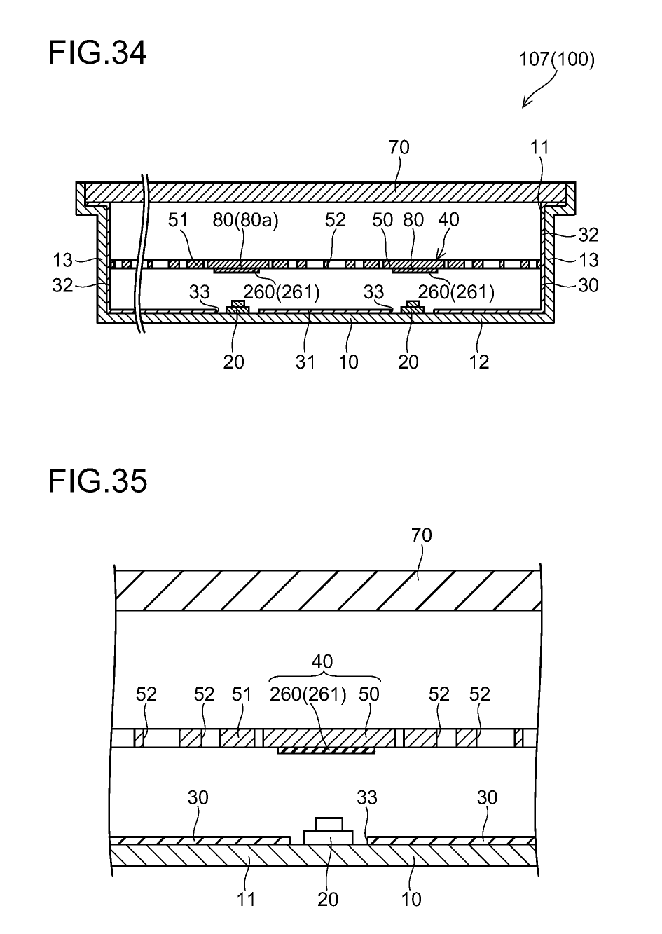

FIG. 34 is a cross-sectional view of a light source module according to a ninth embodiment of the present invention. FIG. 35 is a cross-sectional view showing an enlarged portion of FIG. 34. The light source module according to the ninth embodiment of the present invention will now be described with reference to FIGS. 34 and 35. In the drawings, the corresponding constituent components are identified with common symbols, and therefore their description will not be repeated as appropriate.

In the light source module 107 (100) of the ninth embodiment, as shown in FIGS. 34 and 35, instead of the reflective sheet segment, a reflective layer 260 is formed in a predetermined area. The reflective layer 260 is formed by printing a reflective material 261 on the lighting curtain 50. In other words, the ninth embodiment differs from the first embodiment where the separately formed reflective sheet segments are fixed with the adhesion material in that the reflective layers 260 are formed by the printing and are fixed to the lighting curtain 50.

Although it is possible to form the reflective layer 260 with various printing methods such as silk printing, offset printing and inkjet printing, silk printing among them is preferably used. The formation of the reflective layer 260 (the printing of the reflective material 261) may be performed either before the openings 52 are formed in the lighting curtain 50 or after the openings 52 are formed.

As the reflective material 261, for example, a white ink or a metallic ink can be used. In the metal ink, as compared with the white ink, the reflectance is often low and thus the loss of brightness is increased; however, since its thickness is small, it is possible to achieve a high light blocking ability. The white ink is used for the printing, and thus variations in the color of the light that are thereafter produced are reduced, with the result that the light blocking ability can be enhanced.

In the area (the area on which the reflective layer 260 is formed) to which the reflective material 261 is applied, as compared with the area (the area on which the reflective layer 260 is not formed) to which the reflective material 261 is not applied, the light is reflected off the reflective material 261 (the reflective layer 260). Hence, the light blocking ability of the area is enhanced. In other words, in the configuration described above, with simple means, it is possible to locally enhance the light blocking ability of the lighting curtain 50. Although the thickness of the reflective layer 260 depends on how much the light blocking ability needs to be enhanced, the thickness of the reflective layer 260 can be set at a thickness of 20 μm to 100 μm.

Furthermore, since, in the ninth embodiment, the formation of the reflective layer 260 (the enhancement of the light blocking ability) can be achieved by performing the printing on the lighting curtain 50, as compared with the first embodiment, there is a possibility that it is possible to further reduce the cost.

Although FIGS. 34 and 35 show the example where the reflective layer 260 is formed on the surface of the lighting curtain 50 on the side of the LED packages 20, the reflective layer 260 may be formed on the surface opposite the surface on the side of the LED packages 20. In other words, the formation of the reflective layer 260 (the printing of the reflective material 261) can be performed on any one of the surfaces of the lighting curtain 50. The reflective layer 260 may be formed on both surfaces of the lighting curtain 50.

When the reflective layer 260 is formed on only one of the surfaces and thus the light blocking ability is insufficient, the reflective layer 260 is preferably formed on both surfaces of the lighting curtain 50. In this case, it is not always necessary to print the same pattern on both the surfaces, and different patterns can be printed. When, as described above, different patterns are printed, an area where light is reflected off both surfaces of the reflective layer 260 (the reflective material 261) and an area where light is reflected off only one of the surfaces of the reflective layer 260 (the reflective material 261) are formed, and thus it is possible to form an area that has an intermediate reflectance. It is therefore possible to enhance the flexibility of the design of the printing pattern.

The configuration of the other portions in the ninth embodiment and the other effects of the ninth embodiment are the same as those of the first embodiment.

### Tenth Embodiment

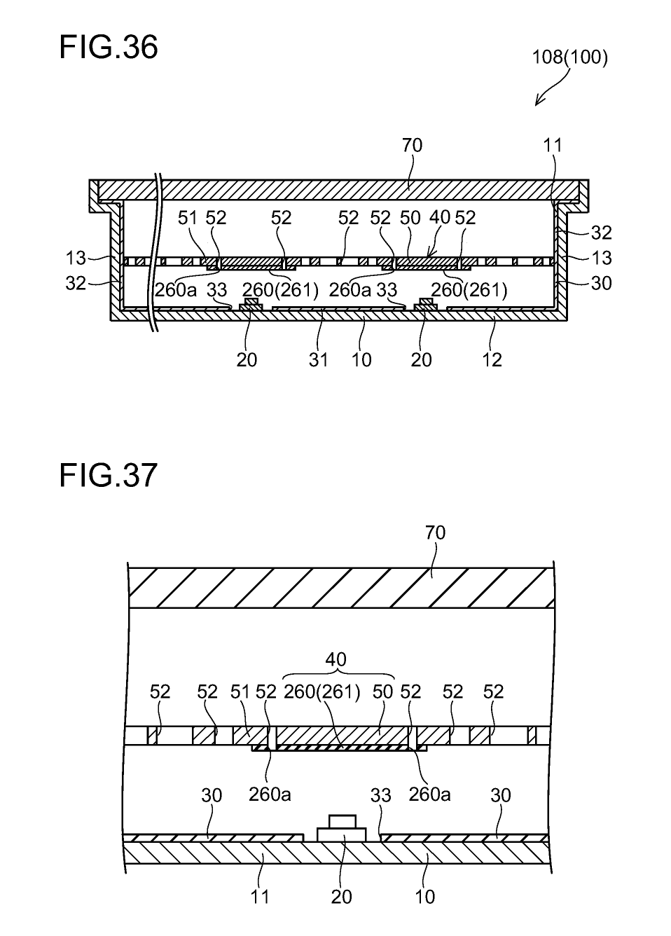

FIG. 36 is a cross-sectional view of a light source module according to a tenth embodiment of the present invention. FIG. 37 is a cross-sectional view showing an enlarged portion of FIG. 36. The light source module according to the tenth embodiment of the present invention will now be described with reference to FIGS. 36 and 37. In the drawings, the corresponding constituent components are identified with common symbols, and therefore their description will not be repeated as appropriate.

The light source module 108 (100) of the tenth embodiment differs from that of the ninth embodiment in that opening holes 260a common to the openings 52 of the lighting curtain 50 are formed in part of the reflective layer 260. In other words, in the tenth embodiment, as shown in FIGS. 36 and 37, the opening holes 260a that are covered by the openings 52 of the lighting curtain 50 are formed in the reflective layer 260.

In the configuration described above, as compared with the case where the reflective material 261 is not applied to even the vicinity of the openings 52, it is possible to enhance the light blocking ability of the reflective portion (the portion where the reflective layer 260 is formed).

The configuration described above can be easily achieved by printing the reflective material 261 (forming the reflective layer 260) on the lighting curtain 50 and then forming the openings 52.

### Eleventh Embodiment

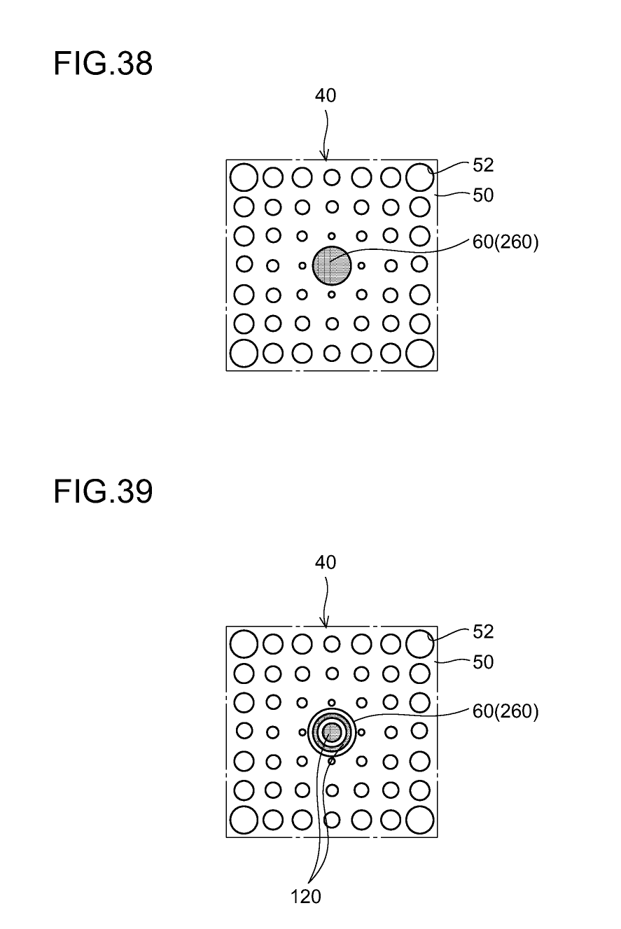

FIGS. 38 to 41 are plan views showing a portion of an optical member according to an eleventh embodiment of the present invention. In the eleventh embodiment, the formation of the reflective sheet segment (the reflective layer) will now be more specifically described with reference to FIGS. 38 to 41.

As shown in FIG. 38, the reflective sheet segment 60 of the optical member 40 can be formed into, for example, a circle. Since the reflective sheet segment 60 is formed with the reflective sheet, the entire surface thereof functions as the reflective portion. The reflective sheet segment 60 described above can be obtained by, for example, applying the adhesion material to the entire surface of one side of the reflective sheet and then cutting out it into a circle. Since the state of the reflective sheet segment that has been subjected to the cutting processing is the adhesive form, it is possible to easily adhere it to the lighting curtain 50.

When the reflective layer 260 is formed by the printing, the reflective material is printed in a circle, and thus it is possible to easily achieve the shape described above.

In another example, as shown in FIG. 39, the reflective sheet segment 60 of the optical member 40 can be formed into, for example, a circle that has a plurality of ring-shaped reflective portions 120. The reflective sheet segment 60 described above can be provided by, for example, printing the reflective material on a transparent plate in a concentric pattern of the reflective portions 120 and applying the adhesion material on the opposite surface of the transparent plate.

When the reflective layer (reflective sheet segment) of such a shape is formed by cutting out the reflective sheet, a plurality of reflective sheet segments are necessary. It is also necessary to conduct the adhering processing to the lighting curtain by performing a plurality of steps, and to perform positioning between the reflective sheet segments. Hence, even when, as described above, the reflective portions 120 are formed by the printing and thus the pattern of the reflective portion is formed by a plurality of reflective portions 120 as shown in FIG. 39, it is possible to provide the reflective sheet segments easily and inexpensive. It is therefore possible to achieve even a fine or complicated shape of the reflective layer on which, depending on the shape, it is difficult to perform processing. When the reflective layer 260 is formed by the printing, it is also possible to likewise achieve the above shape easily.

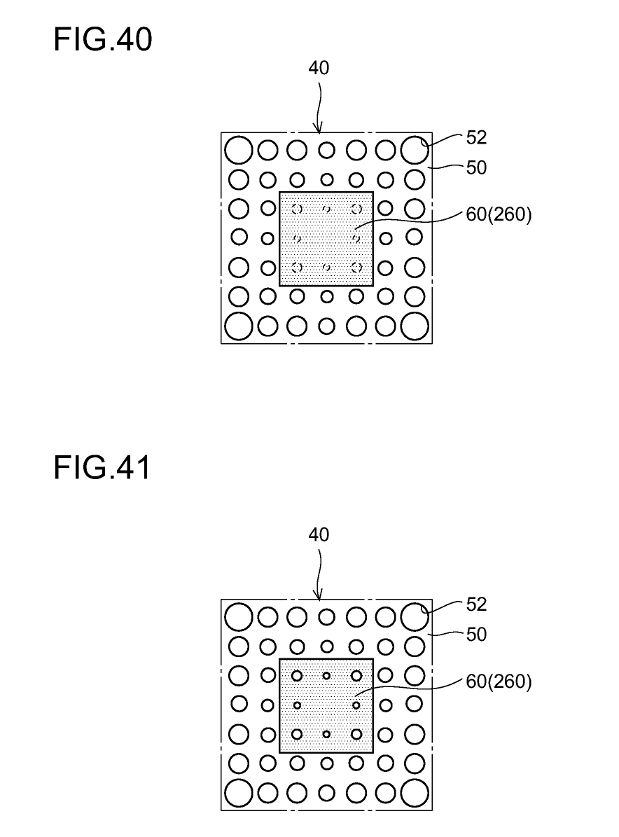

In yet another example, as shown in FIG. 40, the reflective sheet segment 60 of the optical member 40 can also be formed into, for example, a rectangle (square). In this case, for example, it is also possible to arrange the reflective sheet segments 60 so as to cover the openings 52 of the lighting curtain 50. As compared with the portions in which the openings 52 are not present in the lighting curtain 50 and which are covered by the reflective sheet segments 60, the portions of the openings that are covered by the reflective sheet segments 60 have a high transmittance. On the other hand, the portions have a low transmittance as compared with the portions in which the openings 52 are present in the lighting curtain 50 and which are not covered by the reflective sheet segments 60. In other words, the portions of the openings that are covered by the reflective sheet segments 60 can be used as portions that have an intermediate transmittance. In this way, it is possible to increase the flexibility of the design of a transmittance pattern.

The above configuration is utilized in a portion where fine openings are required to be formed in the lighting curtain 50, and thus it is possible to increase the size of the openings. Hence, by making it easy to process the openings 52 of the lighting curtain 50, it is possible to expect cost reduction and the enhancement of the productivity. For example, when a design or production failure or the like occurs and thus the openings of the lighting curtain are larger than those of a proper size, it is also possible to use the reflective sheet segments in order to perform correction.

In yet another example, as shown in FIG. 41, the reflective sheet segment 60 of the optical member 40 can also be formed into, for example, a rectangle (square) in which opening holes having the same shape as the openings 52 of the lighting curtain 50 are provided.

The reflective sheet segment 60 described above can be produced by, for example, fixing the reflective sheet segment 60 and then forming the lighting curtain with press punching processing at the same time that openings are formed in the reflective sheet segment 60. In this configuration, the reflective sheet segments 60 are adhered to only necessary portions, and thus it is possible to obtain the same effects as those obtained when the lighting curtain is formed of a material having a higher light blocking ability. Even when the reflective layer 260 is formed by the printing, it is possible to likewise achieve the above configuration easily.

The configuration shown in FIGS. 38 to 41 can be applied as appropriate to the first to tenth embodiments.

The shape of the reflective sheet segment or the pattern of the reflective material is formed into a circle or a collection of circles, and thus it is possible to perform an optical calculation while reducing a certain amount of calculation. As described above, the shape of the reflective sheet segment or the reflective layer is formed into a circle, and thus it is possible to easily determine whether or not light is incident.

Specifically, it is assumed that the coordinates, on the x-y plane, of the circle for determining whether or not light is incident are (x₀, y₀), that the diameter is r and that the coordinates of light toward the x-y plane in which z is the same as the incident plane are (x₁, y₁). In this case, when the following formula (1) is satisfied, the light can be determined to be applied to the inside of the circle whereas, when the following formula (1) is not satisfied, the light can be determined not to be applied the outside of the circle.

(x₀−x₁)²+(y₀−y₁)²≦r² (1)

For the same reason, the shape of the reflective sheet segment or the pattern of the reflective material (the shape of the reflective layer) may be formed into a quadrangle (rectangle). It is assumed that the quadrangle is a rectangle in which two sides are parallel to the x-axis and two sides are parallel to the y-axis, and that the length of the side in the direction of the x-axis is L₀ and the length of the side in the direction of the y-axis is L₁. It is also assumed that the coordinates, on the x-y plane, of the center of the quadrangle for determining whether or not light is incident are (x₀, y₀), and that the coordinates of light toward the x-y plane in which z is the same as the incident plane are (x₁, y₁). In this case, when the following formula (2) is satisfied, the light can be determined to be applied to the inside of the quadrangle whereas, when the following formula (2) is not satisfied, the light can be determined not to be applied the outside of the quadrangle.

|x₀−x₁|≦L₀/2

and

|y₀−y₁|≦L₁/2 (2)

In another general shape, a determination whether or not light is incident either on the reflective sheet segment or the printed reflective material is complicated, and thus the amount of calculation tends to be increased. However, when, as described above, a simple shape such as a circle or a quadrangle is used, the amount of calculation for verification can be reduced. By reducing the amount of calculation for verification, it is possible to enhance the accuracy of the design and reduce the period of time needed for the design. Hence, the shape of the reflective sheet segment or the reflective layer is preferably formed into a circle or a quadrangle (rectangle).

It is desirable to reduce the thickness of the reflective sheet segment in terms of the amount of calculation. When the thickness is sufficiently small, it is possible to perform the calculation without consideration of the thickness of the reflective sheet segment. Hence, calculation for incidence of light on the side surface of the reflective sheet segment is omitted, and the height of the reflective sheet segment is set equal to the height of one of the surfaces of the lighting curtain, with the result that it is further possible to reduce the calculation. In other words, it is possible to effectively perform the calculation by assuming the thickness of the reflective sheet segment to be 0 (zero). Hence, the reflective sheet segment is preferably at least thinner than that of the lighting curtain. When the reflective material is printed, since, in general, the thickness is significantly small, it is easy to obtain such a preferred feature. Therefore, as long as desired optical characteristics are obtained, the thickness of the reflective sheet segment or the reflective layer is preferably configured to be as small as possible.

### Twelfth Embodiment

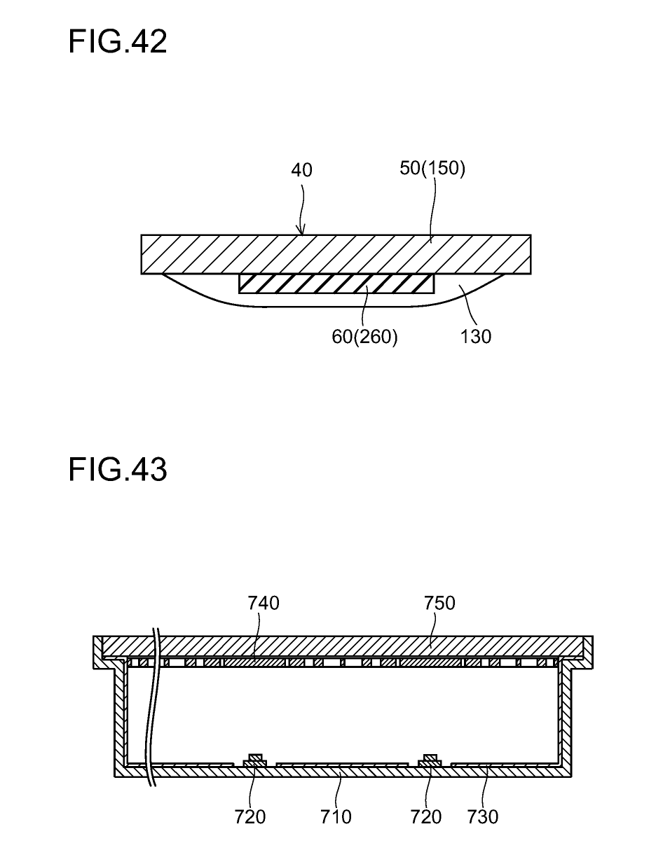

In the embodiments that have been described above, it is likely that the reflective layer formed with the reflective sheet segment, the printed ink and the like falls off. Hence, in order to prevent the reflective sheet segment or the reflective layer from falling off, as shown in FIG. 42, the reflective sheet segment 60 or the reflective layer 260 can also be sealed with a sealant 130. As the sealant 130, a sealant formed of a transparent silicone is preferably used so that optical effects are minimized. However, for example, by using a white sealant or the like, it is also possible to enhance the light blocking ability. The sealing with the sealant is preferably performed with, for example, a method of potting or the like, such that the reflective sheet segment or the reflective layer is covered with the sealant.

It should be considered that the embodiments disclosed herein are illustrative and not restrictive in all respects. The scope of the present invention is indicated not by the description of the above embodiments but by the scope of claims, and further includes meanings equivalent to the scope of claims and all modifications within the scope.

For example, although, in the above embodiments, the example where the reflective sheet segments or the reflective layers are provided on the lighting curtain on the side of the light source (on the side of the LED packages) is described, it is possible to obtain the same effects even when the reflective sheet segments or the reflective layers are provided on the surface opposite the surface on the side of the light source. When the reflective sheet segments or the reflective layers are adhered to the surface on the side of the light source, since the reflective sheet segments or the reflective layers are added to the portions near the light source, the area over which light can be blocked is increased. Since the light diffusion function of the lighting curtain causes the shape of the reflective sheet segments or the reflective layers to be blurred and reach the diffusion plate, variations in brightness produced by the shadow of the reflective sheet segments or the reflective layers are reduced. On the other hand, when the reflective sheet segments or the reflective layers are provided on the side opposite the side of the light source, even if the reflective sheet segment or the like comes off the lighting curtain, it is prevented from falling off to the side of the LED packages. Hence, the possibility that the reflective sheet segment or the like which has come off the lighting curtain makes contact with the electrodes of the LEDs or the like is reduced. Since, in this case, the reflective sheet segments or the reflective layers are positioned far away from the light source, even the reflective sheet segments or the reflective layers whose light blocking ability is relatively low can be used. For mechanical or optical reasons, the reflective sheet segments or the reflective layers are preferably provided on the desired side. When a sufficient light blocking ability is desired, it is effective to provide the reflective sheet segments or the reflective layers on both the sides.

Although, in the above embodiments, a description is given of the example where the lighting curtain is formed with the reflective plate in which the transmission portions are formed by the openings and the example where the lighting curtain in which the reflective material is printed on the transparent plate is used, a lighting curtain other than those described in the above embodiments may be used. Moreover, when, in the lighting curtain, the openings are provided in the reflective plate, it is possible to change, as appropriate, the pattern of the openings or the shape of the openings. For example, the shape of the openings can be formed into a shape other than a circle (for example, an ellipse or a polygon). It is also possible to employ a configuration in which a plurality of openings of the lighting curtain are made equal in size to each other and in which, as the opening is positioned farther away from the area directly above the light source, the space between the adjacent openings is gradually reduced. Furthermore, when, in the lighting curtain, the reflective material is printed on the transparent plate, it is possible to change the printing pattern as appropriate. The lighting curtain can also be configured by printing the reflective material on, for example, the diffusion plate other than the transparent plate.

Although, in the above embodiments, a description is given of the example where the shape of the reflective sheet segment (the reflective layer) is formed into a circle or a rectangle, the present invention is not limited to this example, and the shape of the reflective sheet segment (the reflective layer) is formed into any shape other than the shapes described above. As long as the shape of the reflective sheet segment (the reflective layer) allows the enhancement of the light blocking ability of the area (the area where the light blocking ability is insufficient) on which high-intensity light is incident from the light source, it is possible to employ various shapes such as polygons more than a rectangle and a pentagon, an ellipse, a cross shape and a star shape. Since a complicated shape causes the calculation for determining whether or not light is incident to become complicated, a shape, such as a circle or a rectangle (square) that makes it easy to perform the calculation is preferably employed. The area where the light blocking ability is insufficient may be changed depending on even the opening pattern of the lighting curtain, the printing pattern of the reflective material and the like. In such a case, it is preferable to set, as appropriate, the shape and the size of the reflective sheet segment (the reflective layer), the position of the attachment and the like according to the opening pattern, the printing pattern and the like.

As long as the size of the reflective sheet segment (the reflective layer) allows the enhancement of the light blocking ability of the area (the area where the light blocking ability is insufficient) on which high-intensity light is incident from the light source, the size of the reflective sheet segment (the reflective layer) is not limited. Since high-intensity light is generally incident on the vicinity of the area directly above the LED packages, the size of the reflective sheet segment (the reflective layer) is preferably set such that the reflective sheet segment (the reflective layer) covers the area. When, in the vicinity of the area directly thereabove, no problem is encountered even if the light blocking ability of the area is significantly high, it is also possible to deliberately increase the size of the reflective sheet segment. The size of the reflective sheet segment is increased in this way, and thus it is possible to easily attach the reflective sheet segment.

Although, in the above embodiments, a description is given of the example where the reflective sheet segment (the reflective layer) is attached to the vicinity of the area directly above the LED packages, the reflective sheet segment (the reflective layer) is attached to the area (the area where the light blocking ability is insufficient) on which high-intensity light is incident, and the area is not limited to the vicinity of the area directly above the LED packages. Although high-intensity light is generally incident on the vicinity of the area directly above the LED packages, the distribution of strength of light that is incident on the lighting curtain depends on not only the light distribution characteristic of the LED packages but also the shape and the dimensions of the light source module, the pitch of the LED packages, the type of LED packages, the distance from the reflective sheet to the lighting curtain and the like. Hence, the position of attachment of the reflective sheet segment (the reflective layer) and the like are set according to the area (the area where the light blocking ability is insufficient) on which high-intensity light is incident.

Although, in the above embodiments, a description is given of the example where the LED packages are used as the light source, the light source of the light source module may be a light source (a point light source) other than the LED packages. According to the present invention, even when a light source (a point light source) other than the LED packages is used, it is possible to reduce variations in brightness.

Although, in the eleventh embodiment, a description is given of the example where the lighting curtain is used that is formed with the reflective plate in which the transmission portions are formed by the openings, the present invention is not limited to this example, and, for example, a lighting curtain in which the reflective material is printed on the transparent plate can also be used as the lighting curtain.

In the above embodiments, for example, the reflective sheet segment may be adhered and fixed to one of the surfaces of the lighting curtain, and the reflective material may be printed on the other surface of the lighting curtain. Alternatively, the reflective material may be printed on the lighting curtain, and the reflective sheet segment may be adhered and fixed thereto. In other words, the configurations of a plurality of embodiments may be combined.

As in the first embodiment, the light source modules of the second to twelfth embodiments can be used as the backlight unit of a liquid crystal display device.

Embodiments that are obtained by combining, as appropriate, the technologies disclosed above are also included in the technical scope of the present invention.

What is claimed is:

1. A light source module comprising:
a light source;
a lighting curtain that partially blocks light from the light source; and
a reflective layer that is provided on the lighting curtain and that has a planar shape smaller than the lighting curtain.

2. The light source module of claim 1,
wherein the lighting curtain is formed with a reflective plate in which a transmission portion is formed by an opening.

3. The light source module of claim 2,
wherein an opening hole is provided in the reflective layer so as to cover the opening of the lighting curtain.

4. The light source module of claim 3,
wherein the reflective layer is fixed to the lighting curtain through an adhesion layer, and the adhesion layer is provided in an area in which the adhesion layer is prevented from covering the opening hole of the reflective layer.

5. The light source module of claim 2,
wherein at least part of the opening of the lighting curtain is covered by the reflective layer.

6. The light source module of claim 1,
wherein the lighting curtain is formed with a plate-shaped member in which a transmission portion and a light blocking portion are provided by printing a reflective material.

7. The light source module of claim 6,
wherein the lighting curtain includes:
a transparent plate; and
a print layer that is formed by printing the reflective material on both surfaces of the transparent plate.

8. The light source module of claim 1,
wherein the reflective layer is formed into a separate sheet shape, and the sheet-shaped reflective layer is fixed to the lighting curtain through an adhesion layer,

9. The light source module of claim 8,
wherein the adhesion layer is formed by printing an adhesion material on the sheet-shaped reflective layer.

10. The light source module of claim 8,
wherein the adhesion layer is formed by printing an adhesion material on the lighting curtain.

11. The light source module of claim 8,
wherein the adhesion layer has ultraviolet radiation resistance.

12. The light source module of claim 8,
wherein the adhesion layer is transparent.

13. The light source module of claim 8,
wherein the adhesion layer is white.

14. The light source module of claim 8,
wherein the sheet-shaped reflective layer is fixed to the lighting curtain with a double-faced tape having the adhesion layer.

15. The light source module of claim 14,
wherein the double-faced tape includes a white base material.

16. The light source module of claim 14,
wherein the double-faced tape includes a transparent base material.

17. The light source module of claim 14,
wherein the double-faced tape includes no base material.

18. The light source module of claim 1,
wherein the reflective layer is formed with a first reflective member in which a reflective material is printed on a base material.

19. The light source module of claim 1,
wherein the reflective layer is formed with a second reflective member in which a reflective material is printed on a formed reflective sheet.

20. The light source module of claim 1,
wherein the light source is arranged on a side of one surface of the lighting curtain, and the reflective layer is provided on the surface of the lighting curtain on a side of the light source.

21. The light source module of claim 1,
wherein the light source is arranged on a side of one surface of the lighting curtain, and the reflective layer is provided on a surface of the lighting curtain opposite the surface on a side of the light source.

22. The light source module of claim 1,
wherein the light source is arranged on a side of one surface of the lighting curtain, and the reflective layer is provided on both the surface of the lighting curtain on a side of the light source and a surface opposite the surface on the side of the light source.

23. The light source module of claim 1,
wherein the reflective layer includes:
a first reflective layer that is fixed to the lighting curtain; and
a second reflective layer that has a planar shape smaller than the first reflective layer and that is fixed to the first reflective layer.

24. The light source module of claim 1,
wherein the reflective layer is substantially circular when seen in plan view.

25. The light source module of claim 1,
wherein the reflective layer is substantially quadrangular when seen in plan view.

26. The light source module of claim 1,
wherein the reflective layer has a thickness smaller than the lighting curtain.

27. The light source module of claim 2,
wherein the reflective layer is formed and fixed onto the lighting curtain by printing.

28. The light source module of claim 27,
wherein the reflective layer is formed with a white ink.

29. The light source module of claim 28,
wherein the reflective layer is formed with a metallic ink.

30. The light source module of claim 1,
wherein at least part of the reflective layer is scaled with a sealant.

31. The light source module of claim 1,
wherein the light source is formed with a light-emitting diode.

32. The light source module of claim 1, comprising:
a plurality of the light sources.

33. An optical member comprising:
a lighting curtain that partially blocks light; and
a reflective layer that is provided on the lighting curtain and that has a planar shape smaller than the lighting curtain.
